(19) United States
(12) Patent Application Publication
(10) Pub. No.: US 2026/0179137 A1
(43) Pub. Date: Jun. 25, 2026

(54) COMPUTER ARCHITECTURE FOR INTERACTIVE IMAGE BASED DATABASE SEARCHING

(71) Applicant: RAKUTEN GROUP, INC., Tokyo (JP)

(72) Inventor: Kazuhiro SEKINE, Tokyo (JP)

(73) Assignee: RAKUTEN GROUP, INC., Tokyo (JP)

(21) Appl. No.: 19/428,652

(22) Filed: Dec. 22, 2025

(30) Foreign Application Priority Data
Dec. 24, 2024 (JP) 2024-227525

(51) Int. Cl. G06Q 30/0601; G06F 16/532; G06F 16/535; G06F 16/538; G06F 16/55

(52) U.S. Cl. CPC G06Q 30/06311; G06F 16/532; G06F 16/535; G06F 16/538; G06F 16/55

(57) ABSTRACT

A computer architecture for interactive image based database searching includes a first server that acquires category information indicating a category of a vehicle owned by a user. The first server also acquires part information for identifying a vehicle part located at a position specified by a user operation within an image of a vehicle displayed on a terminal device of the user. A second server is in communication with the first server and searches for products by accessing a storage storing thereon product information on vehicle part products and by using the acquired category information and the acquired part information as search criteria. The system transmits search result information indicating results of the search to the terminal device.

### CROSS REFERENCE TO RELATED APPLICATION

This application claims priority from Japanese Patent Application No. 2024-227525 which was filed on Dec. 24, 2024, the disclosure of which is herein incorporated by reference in its entirety.

### BACKGROUND

### Technical Field

The present disclosure relates to a computer architecture for interactive image based database searching.

### Related Art

There are conventionally known transaction systems that enable product purchases via electronic commerce. A general transaction system searches for products meeting criteria designated by a user and provide information on found products.

There are also known systems that search for products using images. For example, JP 2017-228177 A discloses recognizing one or more objects from image-by-image recognition procedures to the image, displaying one or more object identifiers for identifying the one or more objects, receiving a user operation to select an object identifier, and transmitting information on a product related to an object identified with the selected object identifier.

### SUMMARY

There is a system that enables purchase of vehicle parts, among the transaction systems. It is natural that a user wishes to purchase a vehicle part that is compatible with a vehicle of the user. However, even if vehicle parts have the same name or the same type, these vehicle parts may be suitable for different vehicles to each other. In conventional technology, this point has not been considered. Furthermore, existing image-based search systems typically require computationally intensive image recognition processing for each user interaction, leading to increased processing time and server load. There is a need for a technical solution that efficiently correlates user interactions with vehicle images to specific vehicle parts while simultaneously filtering products based on vehicle compatibility, thereby reducing both user effort and computational overhead.

The present disclosure has been made in view of the above points, and an example of an object of the present disclosure is to provide a computer architecture for interactive image based database searching capable of searching for vehicle part products corresponding to a vehicle owned by a user based on an operation on an image.

An aspect of the application is a product search system comprising: at least one memory configured to store computer program code; and at least one processor configured to access the memory and operate as instructed by the computer program code, the computer program code comprising: category information acquisition code configured to cause at least one of the at least one processor to acquire category information indicating a category of a vehicle owned by a user; part information acquisition code configured to cause at least one of the at least one processor to acquire part information for identifying a vehicle part located at a position specified by a user operation within an image of a vehicle displayed on a terminal device of the user; search code configured to cause at least one of the at least one processor to search for products by accessing a storage storing thereon product information on vehicle part products and by using the acquired category information and the acquired part information as search criteria; and search result transmission code configured to cause at least one of the at least one processor to transmit search result information indicating results of the search to the terminal device. The disclosed computer architecture provides technical improvements over conventional product search systems by integrating image-based part selection with compatibility-based filtering, thereby reducing the number of search iterations required and improving search accuracy. By utilizing a segment map that associates pixel coordinates with vehicle part identifiers, the system eliminates the need for repeated image recognition processing for each user interaction with the same vehicle image.

Furthermore, the dual-criteria filtering approach (category compatibility and part identification) reduces the computational burden on the search system by reducing database query times through optimized indexing structures and narrowing the search space before executing database queries, thereby improving system performance and reducing network bandwidth consumption.

Another aspect of the application is A product search method performed by at least one computer, the method comprising: acquiring category information indicating a category of a vehicle owned by a user; acquiring part information for identifying a vehicle part located at a position specified by a user operation within an image of a vehicle displayed on a terminal device of the user; searching for products by accessing a storage storing thereon product information on vehicle part products and by using the acquired category information and the acquired part information as search criteria; and transmitting search result information indicating results of the search to the terminal device.

Yet another aspect of the application is a non-transitory computer readable medium having stored thereon a product search program which, when executed by at least one processor, causes a computer to: acquire category information indicating a category of a vehicle owned by a user; acquire part information for identifying a vehicle part located at a position specified by a user operation within an image of a vehicle displayed on a terminal device of the user; search for products by accessing a storage storing thereon product information on vehicle part products and by using the acquired category information and the acquired part information as search criteria; and transmit search result information indicating results of the search to the terminal device.

### BRIEF DESCRIPTION OF DRAWINGS

FIG. 1 is a diagram illustrating an example of a schematic configuration of a communication system according to an embodiment.

FIG. 2 is a block diagram illustrating an example of a schematic configuration of an automobile service server 1 according to the embodiment.

FIG. 3 is a diagram illustrating an example of information stored in databases in the automobile service server 1.

FIG. 4 is a block diagram illustrating an example of a schematic configuration of a product transaction server 2 according to the embodiment.

FIG. 5 is a diagram illustrating an example of information stored in databases in the product transaction server 2.

FIG. 6 is a diagram illustrating an example of functional blocks of a system controller 11 in the automobile service server 1 according to the embodiment.

FIG. 7A is a diagram illustrating an example of a part selection screen, and FIG. 7B is a diagram illustrating another example of a part selection screen.

FIG. 8A is a diagram illustrating an example of the part selection screen wen a vehicle part is selected, and FIG. 8B is a diagram illustrating another example of the part selection screen when a vehicle part is selected.

FIG. 9 is a diagram illustrating an example of functional blocks of a system controller 21 in the product transaction server 2 according to the embodiment;

FIG. 10 is a diagram illustrating an example of product search.

FIG. 11 is a sequence diagram illustrating an example of processing by the communication system S according to the embodiment.

FIG. 12 is a flowchart illustrating an example of product search processing executed by a system controller 21 of the product transaction server 2 according to the embodiment.

FIG. 13 is a block diagram illustrating an example of a schematic configuration of an automobile service server 1 according to an embodiment.

FIG. 14 is a diagram illustrating an example of information stored in databases in the automobile service server 1.

FIG. 15 is a sequence diagram illustrating an example of a processing by the communication system s according to the embodiment.

FIG. 16 is a block diagram illustrating an example of a schematic configuration of an automobile service server 1 according to an embodiment.

FIG. 17 is a diagram illustrating an example of information stored in a database in the automobile service server 1.

FIG. 18 is a diagram illustrating an example of functional blocks of a system controller 11 in the automobile service server 1 according to the embodiment.

FIG. 19 is a diagram illustrating an example of vehicle categories and vehicle part purchase status.

FIG. 20 is a diagram illustrating an example of product search.

FIG. 21 is a sequence diagram illustrating an example of processing by the communication system S when vehicle category association information is generated.

FIG. 22 is a sequence diagram illustrating an example of processing by the communication system S when a vehicle part product search is executed.

FIG. 23 is a sequence diagram illustrating an example of processing by the communication system S when a vehicle part product search is executed.

### DETAILED DESCRIPTION

### 1. First Embodiment

Hereinafter, embodiments related to a product search system of the present disclosure will be described in detail with reference to the drawings. The product search system may be a system for searching for products. In particular, the product search system may be a system for vehicle part products. Examples of vehicles to which the present disclosure can be applied include automobiles, motorcycles and bicycles. In the embodiments to be described below, vehicles are, for example, automobiles.

### 1-1. Configuration of Communication System

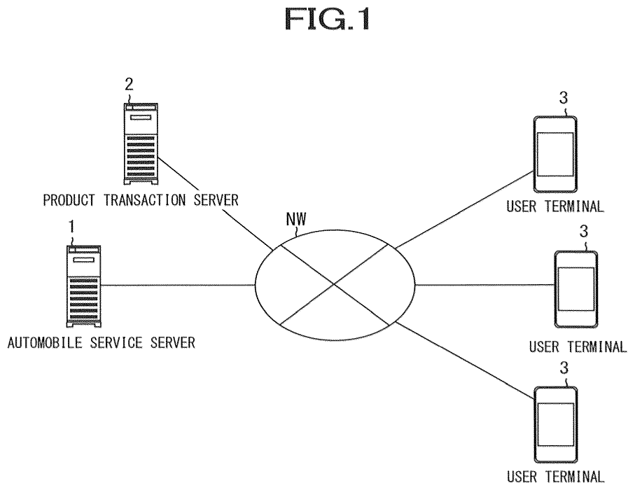

First, an outline of a configuration and a function of a communication system S according to the present embodiment will be described with reference to FIG. 1. FIG. 1 is a diagram illustrating an example of a schematic configuration of a communication system S according to the present embodiment.

As illustrated in FIG. 1, the communication system S includes an automobile service server 1, a product transaction server 2, and user terminals 3. The automobile service server 1, the product transaction server 2, and the user terminals 3 are connected to each other via a network NW. The network NW is constructed by, for example, the Internet, a dedicated communication line (for example, a community antenna television (CATV) line), a mobile communication network (including a base station and the like), a gateway, and the like. The combination of the automobile service server 1 and the product transaction server 2 may be an example of a product search system. The product search system may be a system for searching for products. Furthermore, the vehicle automobile server 1 and the product transaction server 2 may be integrated into a single device.

The two-server architecture comprising the automobile service server 1 and the product transaction server 2 may provide various technical benefits. By distributing processing tasks between the two servers, the system may achieve improved scalability, as each server can be independently scaled based on its respective workload. For example, the product transaction server 2 may experience higher computational demands during product searches across large product databases, while the automobile service server 1 may experience higher demands when processing vehicle image data and segment maps. The distributed architecture may allow each server to be optimized for its specific functions.

The two-server architecture may also provide improved system reliability and fault tolerance. In some aspects, if one server experiences a temporary failure or requires maintenance, the other server may continue to operate independently for its respective functions. For example, users may continue to access automobile service features provided by the automobile service server 1 even if the product transaction server 2 is temporarily unavailable, and vice versa.

In some cases, the two-server architecture may enhance data security by maintaining separation between different types of data. The automobile service server 1 may store sensitive user information such as owned-vehicle information and vehicle purchase history, while the product transaction server 2 may store product information and product purchase history. This separation may allow different security policies and access controls to be applied to each server based on the sensitivity of the data stored thereon.

The two-server architecture may also reduce network latency in some implementations. The automobile service server 1 may be configured to handle user-facing interactions, including transmitting vehicle images and receiving user operations specifying positions within the images. By processing the segment map and acquiring part information at the automobile service server 1, the system may reduce the amount of data that needs to be transmitted between servers. The automobile service server 1 may transmit only the acquired category information and part information to the product transaction server 2, rather than transmitting raw image data or coordinate data, thereby reducing network bandwidth consumption between the servers.

Furthermore, the two-server architecture may facilitate integration with existing systems. In some aspects, an organization operating an existing automobile service may integrate vehicle part product search functionality by establishing communication with a separate product transaction server 2, without requiring significant modifications to the existing automobile service server 1 infrastructure. Similarly, an organization operating an existing product transaction service may extend its services to support image-based vehicle part searches by establishing communication with an automobile service server 1. This modularity may reduce implementation costs and development time when deploying the product search system.

In some implementations, the two-server architecture may enable specialized optimization of each server. The automobile service server 1 may be optimized for machine vision image processing tasks, including storage and retrieval of vehicle images and segment maps, while the product transaction server 2 may be optimized for database search operations across large volumes of product information. Each server may utilize hardware configurations, caching strategies, and indexing techniques suited to its respective processing tasks, thereby improving overall system performance compared to a single server handling all functions.

The automobile service server 1 may be a server device that executes procedure related to a specific automobile service. The automobile service is a service related to automobiles as an example of vehicles. The automobile service may provide services of automobile sales, automobile trade-in, reservation brokerage for vehicle inspection, and reservation brokerage for automobile repair. The vehicle service server 1 may, for example, perform processes such as searching for a vehicle, providing the results of the search, and handling procedures for purchasing a vehicle. The automobile service server 1 may also transmit various information related to the automobile service to the user terminal 3. For example, the automobile service server 1 may transmit content of a website of the automobile service.

The product transaction server 2 may be a server device that executes procedure related part 1 to a specific product transaction service. The product transaction service is a service that enables users to purchase products via electronic commerce. In particular, the product transaction service may be a service that enables users to purchase products. Products that can be purchased via the product transaction service include automotive part products. The automotive parts as products may include automotive parts with which users who purchased the automotive parts can replace another automotive part or automotive parts with which employees of automotive supply stores can replace another automotive part. The product transaction service may be a service that enables users to purchase automotive parts from only a single seller or may be a service that enables users to purchase automotive parts from multiple sellers. The seller may be a business operator or a person that sells products via the product transaction service. Examples of the sellers include stores. In the following description, the product transaction service may be a service that enables users to purchase products in a specific online shopping mall. In the online shopping mall, multiple sellers may sell products. The product transaction server 2 may execute procedure such as searching for products, providing results of the search, receiving orders for products, and providing details of the orders to the sellers. The product transaction server 2 may also transmit various information related to the product transaction service to the user terminal 3. For example, the product transaction server 2 may transmit content of the online shopping mall.

Each user terminal 3 may be a terminal device used by a user who can use the automobile service and the product transaction service. Examples of the user terminal 3 include a portable information terminal such as a smartphone or a tablet computer, a mobile phone, a personal digital assistant (PDA), a personal computer, a set top box, and the like. A web browser may be installed in each user terminal 3. An application for the automobile service and an application for the product transaction service may be installed in a specific type of user terminal 3. Through the web browser or the application for the automobile service, each user terminal 3 may communicate with the automobile service server 1 and receive information from the automobile service server 1. Further, through the web browser or the application for the product transaction service, each user terminal 3 may communicate with the product transaction server 2 and receive information from the product transaction server 2.

### 1-2. Configurations of Devices

### 1-2-1. Automobile Service Server

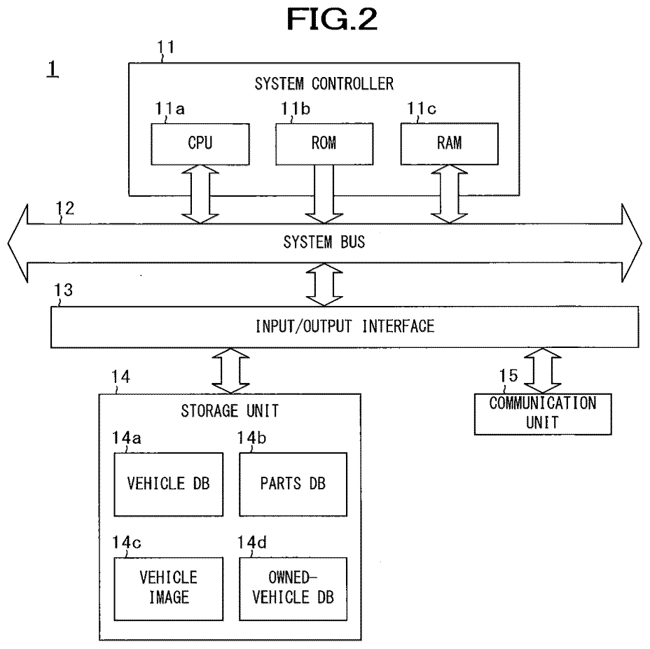

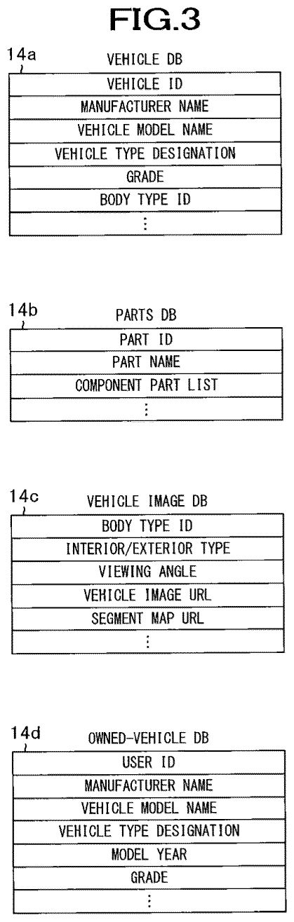

Next, a configuration of the automobile service server 1 will be described with reference to FIGS. 2 and 3. FIG. 2 is a block diagram illustrating an example of a schematic configuration of the automobile service server 1 according to the present embodiment. As illustrated in FIG. 2, the automobile service server 1 includes a system controller 11, a system bus 12, an input/output interface 13, a storage unit 14, and a communication unit 15. The system controller 11 and the input/output interface 13 are connected to each other via the system bus 12.

The system controller 11 includes a central processing unit (CPU) 11a, a read only memory (ROM) 11b, a random access memory (RAM) 11c, and the like.

The input/output interface 13 performs interface processing between the storage unit 14 and the system controller 11 and between the communication unit 15 and the system controller 11.

The storage unit 14 includes, for example, a hard disk drive or the like. The storage unit 14 may store databases that include a vehicle DB 14a, a parts DB 14b, a vehicle image DB 14c, and an owned-vehicle DB 14d, and the like. The “DB” is an abbreviation for a database.

FIG. 3 is a diagram illustrating an example of information stored in databases in the automobile service server 1. The vehicle DB 14a may store thereon vehicle basic information related a vehicle for each category of vehicle. The category in this case may be identified with a combination of a vehicle type designation and a grade. The vehicle basic information may include information indicating one or more items of categories on the vehicle. The item of the category may indicate how to classify the vehicle. Examples of the item include a manufacturer, a vehicle model, a vehicle type designation, a grade, a model year, and body type. As illustrated in FIG. 3, the vehicle DB 14a may store a vehicle ID, a manufacturer name, vehicle model name, a vehicle type designation, a grade, and a body type ID in association with each other as the vehicle basic information. The vehicle ID may be identification information for identifying the vehicle. The manufacturer name may be a name of a manufacturer. The manufacturer may be a party that manufactured the vehicle. The vehicle model name may be a name of the vehicle model. The vehicle model in the embodiment may indicate a category of the vehicle identified with a name given by the manufacturer to the vehicle. Examples of the vehicle model name include “Prius” (registered trademark) and “March” (registered trade mark). The vehicle type designation may indicate a type of the vehicle. The vehicle type identified with the vehicle type designation is a specific type classified by features of the vehicle such as the basic configuration, equipment, and exterior design. The grade may indicate a grade of the vehicle. Example of the grade include C, L, R, G, GT, S, D, none grade, and the like. The body type ID may be identification information for identifying a body type of the vehicle. The body type may indicate, for example, a category of vehicle defined based on vehicle's shape, size, interior specifications, intended use, and the like. Examples of the body types include compact cars, sedans, station wagons, coupes, convertibles, SUVs (Sport Utility Vehicles), and minivans.

The parts DB 14b may store part basic information regarding vehicle parts, for example, for each vehicle part identified by a generic name or for each type of vehicle part. Examples of vehicle part types include grilles, horns, door mirrors, door panels, windshields, side steps, wings, speedometers, tachometers, meter panels, console panels, seats, seat belts, shift knobs, steering wheels, pedals, headlamps, room lamps, turn signal lamps, tires, and wheels. As illustrated in FIG. 3, for example, the parts DB 14b may store, as the basic part information, a part ID, a part name, and a component part list in association with each other. The part ID may be identification information for identifying a vehicle part. The part name may indicate the name of the vehicle part. The part name may be a generic name of the vehicle part or a name indicating the type of the vehicle part. The component part list may be a list of part IDs of other vehicle parts included in the vehicle part. For example, assume that a console panel includes a shift knob and a drink holder. In this case, the component part list of the console panel may include a part ID of each of the shift knob and the drink holder.

The vehicle image DB 14c may store vehicle image information for each vehicle image. The vehicle image is an image of a vehicle. The vehicle image may be, for example, an image generated by two-dimensional or three-dimensional computer graphics. Alternatively, the vehicle image may be a photographic image of the vehicle. The vehicle image may be prepared, for example, for each vehicle category. Examples of such vehicle categories include body type, vehicle model, vehicle type designation, a combination of vehicle model and grade, and a combination of vehicle type designation and grade. In the following description, it is assumed that the vehicle images are prepared for each body type. Furthermore, the vehicle images may be prepared separately for the exterior and interior of the vehicle. The exterior vehicle image may be an image showing the vehicle's exterior appearance. The interior vehicle image may be an image showing the interior of the vehicle. In addition, the vehicle image for the exterior may be prepared for each viewing angle. The viewing angle may indicate from which angle the vehicle is shown in the vehicle image. As shown in FIG. 3, the vehicle image DB 14c may store, as the vehicle image information, a body type ID, an interior/exterior type, a viewing angle, a vehicle image URL (Uniform Resource Locator), and a segment map URL, in association with one another. The body type ID may indicate the body type of the vehicle shown in the vehicle image. The interior/exterior type may indicate whether the vehicle image is an interior or exterior image. The viewing angle may be valid only when the interior/exterior type indicates the exterior. The vehicle image URL may be identification information for identifying the image data of the vehicle image. Examples of the image data format include JPEG, TIFF, and PNG. The image data of the vehicle image may be stored in the storage unit 14 in association with the vehicle image URL. The segment map URL may be identification information for identifying the data of a segment map corresponding to the vehicle image. The segment map may be a map that associates each coordinate or each pixel in the vehicle image with a vehicle part. For example, the segment map may be a two-dimensional array having a size corresponding to the number of pixels in the vertical and horizontal directions of the vehicle image. Each element in the segment map may be information identifying the vehicle part that is represented by the pixel corresponding to that element as the vehicle part. The information identifying the vehicle part may be, for example, a part ID. The elements corresponding to pixel coordinates that do not represent any vehicle part may include information indicating that there is no vehicle part. The data of the segment map may be stored in the storage unit 14 in association with the segment map URL. For example, in a case where a predetermined device or the automotive service server 1 generates vehicle images using three-dimensional computer graphics, polygons in a three-dimensional vehicle model that is compatible with vehicle parts may be associated with information identifying those parts. When rendering the vehicle model, the device may determine, for each pixel of the vehicle image, the vehicle part information associated with the polygon corresponding to that pixel. The device may then generate a segment map including the identified vehicle part information for each coordinate or pixel. When the vehicle image is a photographic image of a vehicle, the predetermined device or the automotive service server 1 may identify the vehicle parts using image recognition technology. For example, the device may generate a segment map by performing segmentation to divide the vehicle image into regions corresponding to respective vehicle parts and other regions. The segmentation may be implemented, for example, using machine learning.

The owned-vehicle DB 14d may store owned-vehicle information regarding a vehicle owned by a user, for each user who has registered the vehicle. For example, as illustrated in FIG. 3, the owned-vehicle DB 14d may store, as the owned-vehicle information, a user ID, a manufacturer name, a vehicle model name, a vehicle type designation, a model year, and a grade, in association with each other. The user ID may be identification information for identifying the user. The manufacturer name, the vehicle model name, the vehicle type designation, and the grade may respectively indicate the manufacturer, the vehicle model, the vehicle type, and the grade of the vehicle owned by the user. The model year may indicate the year in which the vehicle was manufactured. Each user can register the vehicle they own in the automobile service by operating the user terminal 3. For example, the user selects the manufacturer and the vehicle model of the vehicle, and inputs the vehicle type designation, the model year, and the grade. Input of some information may be optional. The user terminal 3 transmits the selected manufacturer name and vehicle model name, and the input vehicle type designation, model year, and grade to the automobile service server 1. The automobile service server 1 generates owned-vehicle information including the information received from the user terminal 3 and the user ID of the user. The automobile service server 1 stores the generated owned-vehicle information in the owned-vehicle DB 14d.

The storage unit 14 may further store various programs such as an operating system, a database management system (DBMS), and an automobile service program. The automobile service program is a program that causes the system controller 11 to execute processing related to the automobile service. The automobile service program may be acquired from, for example, another device via the network NW, or may be recorded on a recording medium such as a magnetic tape, an optical disc, or a memory card and read via a drive device.

The communication unit 15 includes, for example, a network interface card or the like. The communication unit 15 is connected to devices other than automobile service server 1 via the network NW and controls a communication state with the connected devices.

### 1-2-2. Product Transaction Server

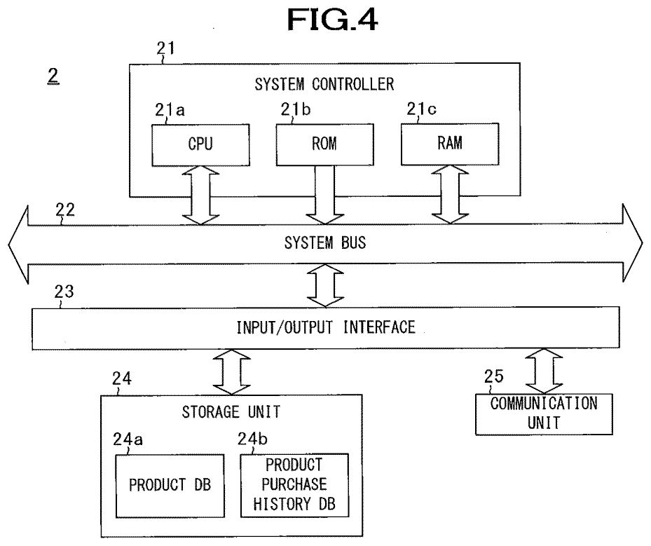

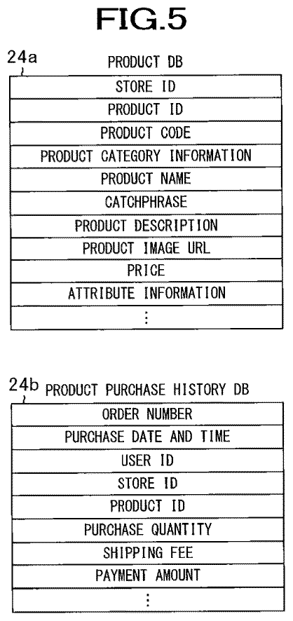

Next, a configuration of the product transaction server 2 will be described with reference to FIGS. 4 and 5. FIG. 4 is a block diagram illustrating an example of a schematic configuration of the product transaction server 2 according to the present embodiment. As illustrated in FIG. 4, the product transaction server 2 includes a system controller 21, a system bus 22, an input/output interface 23, a storage unit 24, and a communication unit 25. The system controller 21 and the input/output interface 23 are connected to each other via the system bus 22.

The system controller 21 includes a CPU 21a, a ROM 21b, a RAM 21c, and the like.

The input/output interface 23 performs interface processing between the storage unit 24 and the system controller 21 and between the communication unit 25 and the system controller 21.

The storage unit 24 includes, for example, a hard disk drive or the like. The storage unit 24 may store databases that include a product DB 24a, product purchase history DB 24b, and the like.

FIG. 5 is a diagram illustrating an example of information stored in databases in the product transaction server 2. The product DB 24a or the storage unit 14 may be an example of a product information storage means. The product information storage means may store product information. The product information may be information on a product. The product information may be information that can be registered by, for example, an employee of a store that sells the corresponding product. The product information storage means may store product information for vehicle part products. The product DB 24a may store product information of products available for purchase through the product transaction service. For example, the product information may be stored for each product. When the product transaction service is a service that enables the purchase of products through an online shopping mall, the product information may be stored for each combination of a product and a store that sells the product. As shown in FIG. 5, the product DB 24a may store, as the product information, a store ID, a product ID, a product code, product category information, a product name, catchphrase, a product description, a product image URL, price, attribute information, and the like, in association with one another. The store ID may be identification information for identifying a store that sells the product. The product ID and product code may each be identification information for identifying the product. The product ID may be identification information assigned by the store that sells the product for identifying that product within the store. The product code may be unique identification information predetermined for the product regardless of the store that sells it. An example of a product code is a Japanese Article Number (JAN) code. The product category information may indicate a category to which the product belongs. The product categories may, for example, be defined hierarchically. Examples of top-level categories include fashion, gourmet, daily goods, home appliances, automobiles/motorcycles, and the like. Examples of subcategories one level below automobiles/motorcycles include car and motorcycle accessories, cars, and motorcycles. Examples of subcategories one level below car and motorcycle accessories include car accessories and motorcycle accessories. Examples of subcategories one level below car accessories include accessories, vehicle parts, tires, wheels, and the like. The product category information may include, for example, product category IDs for each category from the top-level category to the lowest-level category to which the product belongs. A product category ID may be identification information for identifying a category. The product name may indicate a name assigned to the product by the store. The catchphrase may indicate a promotional phrase specified by the store that sells the product. The product description may indicate a description of the product specified by the store that sells the product. Each of the product name, the catchphrase, and the product description may be, for example, text data. The product image URL may be identification information for identifying image data of a product image for the product. The product image may be an image of the product. The image data of the product image may be stored in the storage unit 24 in association with the product image URL. The attribute information may be information indicating attributes of the product with respect to items defined according to the category to which the product belongs.

Among pieces of the product information of vehicle parts stored in the product DB 24a, at least one piece of product information may include product part information and part-compatible vehicle category information. The product part information may be identification information for identifying a vehicle part. The product part information may indicate a type of the vehicle part or may indicate one of categories of vehicle parts classified by general names of the vehicle part. The part-compatible vehicle category information may be information indicating a category of vehicles compatible with the vehicle part. Examples of vehicle categories include the manufacturer, vehicle model, vehicle type designation, grade, model year, and any combination of two or more of these categories. Examples of vehicles compatible with a vehicle part include a vehicle to which the vehicle part is applicable, a vehicle into which the vehicle part can be installed, a vehicle in which the vehicle part operates normally when installed, a vehicle that operates normally when the vehicle part is installed, and a vehicle in which the p vehicle art does not cause a design inconsistency when installed. Which category of vehicles the vehicle part is compatible with is usually determined by the manufacturer of the vehicle part. In addition, the category of vehicles that are compatible with the vehicle part is generally described on the vehicle part itself, on its packaging, or in its manual. At least one of the product part information and the part-compatible vehicle category information may be included in at least one text of the product name, the catchphrase, and the product description. As an example of the product part information, the part name may be included in the text. As an example of the part-compatible vehicle category information, the name of the vehicle category may be included in the text. As described later, these texts are presented to the user. Therefore, the text in the product information of the vehicle part generally includes the part name. Furthermore, in general, the text in the product information of the vehicle part includes the name of the category of vehicles that are compatible with the vehicle part. At least one of the product part information and the part-compatible vehicle category information may be included in product category information. For example, among automotive products, vehicle part products may be classified into product categories according to a type of the vehicle part. In this case, the product category information of the part product may include, as an example of the product part information, a product category ID indicating the type of the vehicle part. Alternatively, a vehicle part product may be classified into a product category according to the category of vehicles that are compatible with the vehicle part. In this case, the product category information of the vehicle part product may include, as an example of the part-compatible vehicle category information, a product category ID indicating the category of vehicles that are compatible with the vehicle part. Furthermore, in a case where products are categorized by the type of the vehicle part, the attribute information of the vehicle part product may include, as an example of part-compatible vehicle category information, information indicating the category of vehicles that are compatible with the vehicle part.

The storage unit 24 may store, for each piece of product information stored in the product DB 24a, information of a product screen. The product screen is a screen corresponding to the product associated with the product information. For example, the product screen may be a screen including information on the product. Such information may include, for example, the product name, the product image, the catchphrase, the product description, the price, and the like. Furthermore, the product screen may be a screen capable of accepting an operation for purchasing or ordering the corresponding product. For example, the product screen may include an operable element for purchasing the product. Examples of operable elements include buttons, links, icons, lists, and the like. Examples of the operation for purchasing the product include an operation to start a purchase procedure or an operation to add the product to a shopping cart. The purchase procedure may include processing that allows the user to determine the order details of the product, or processing that allows the user to confirm the order details. Examples of order details include the purchase quantity of the product, a payment method, a delivery method, and a delivery destination of the product. The purchase procedure may further include processing for finalizing the order details. In addition, the purchase procedure may include settlement processing for enabling the user to pay the purchase price to the product transaction server 2. Furthermore, the purchase procedure may include processing in which the product transaction server 2 notifies the store that sells the purchased product of the order details. The shopping cart may be a virtual container or list in which the user places products intended to be purchased later. The user can perform the purchase procedure for products placed in the shopping cart. Information of the product screen may be, for example, screen information. The screen information may be information indicating a specific screen. The screen information may also be information for displaying the specific screen on the user terminal 3. The screen information may be, for example, a HyperText Markup Language (HTML) document. In this case, the screen may be referred to as a web page or simply a page. Alternatively, the screen information may be information indicating contents or individual elements displayed on the user terminal 3. Alternatively, the screen information may be information instructing the user terminal 3 to display a specific screen. Based on such instructions, the user terminal 3 may acquire from the automobile service server 1 or another device the information indicating the contents or elements to be displayed, and display them accordingly.

The product purchase history DB 24b may be a database that stores product purchase history information indicating a purchase history of products in the product transaction service. The product purchase history DB 24b may include information indicating the purchased products and the users who purchased those products. Each time a product is purchased, a product purchase log may be stored in the product purchase history DB 24b. The product purchase log may be information indicating a record of a product purchase. For example, as illustrated in FIG. 5, the product purchase history DB 24b may store, as the product purchase log, an order number, purchase date and time, a user ID, a store ID, a product ID, a purchase quantity, a shipping fee, and a payment amount, in associated with one another. The order number may be a number for identifying a purchase or order of a product. The purchase date and time may indicate when the product was purchased. The user ID may indicate the user who purchased the product. The store ID may indicate the seller that sells the purchased product. The product ID may indicate the product purchased from the store. The purchase quantity may indicate how many units of the product were purchased. The payment amount may indicate the amount of money the user paid for purchasing the product.

The use of separate databases, including the vehicle DB 14a, the parts DB 14b, the vehicle image DB 14c, the owned-vehicle DB 14d, the product DB 24a, and the product purchase history DB 24b, may provide various technical benefits. By organizing data into distinct databases based on data type and function, the system may achieve improved query performance. Each database may be independently indexed and optimized for the specific types of queries performed against it. For example, the vehicle image DB 14c may be optimized for retrieval of image data and segment maps based on body type and viewing angle, while the product DB 24a may be optimized for text-based searches across product names, catchphrases, and product descriptions.

The separate database architecture may also improve data management efficiency. Each database may have different storage requirements and access patterns. For example, the vehicle image DB 14c may store large image files and segment map data that are accessed relatively infrequently but require high throughput when accessed, while the owned-vehicle DB 14d may store smaller records that are accessed frequently during user authentication and category information acquisition. By maintaining separate databases, storage resources and caching strategies may be tailored to the specific characteristics of each data type.

In some aspects, the separate database architecture may facilitate concurrent access and reduce contention. During a product search operation, the system may need to access multiple databases in sequence or in parallel. For example, the category information acquisition unit 1101 may access the owned-vehicle DB 14d to acquire category information while the image transmission unit 1102 accesses the vehicle image DB 14c to retrieve vehicle image data. By maintaining these as separate databases, concurrent read operations may be performed without contention, thereby reducing latency and improving system responsiveness.

The separate database architecture may also enhance system maintainability and flexibility. Each database may be independently updated, backed up, or migrated without affecting the other databases. For example, the product DB 24a may be updated frequently as sellers add new products or modify product information, while the vehicle DB 14a may be updated less frequently when new vehicle models are introduced. The separation may allow different update schedules and maintenance windows for each database based on its specific requirements.

In some implementations, the separate database architecture may improve data integrity and consistency. Each database may enforce its own constraints and validation rules appropriate to the data stored therein. For example, the vehicle DB 14a may enforce referential integrity between vehicle type designations and body type IDs, while the product DB 24a may enforce constraints on product category information. By maintaining separate databases with specific validation rules, the system may reduce the risk of data corruption or inconsistency.

The distribution of databases between the automobile service server 1 and the product transaction server 2 may provide additional technical benefits. The vehicle DB 14a, the parts DB 14b, the vehicle image DB 14c, and the owned-vehicle DB 14d may be stored in the storage unit 14 of the automobile service server 1, while the product DB 24a and the product purchase history DB 24b may be stored in the storage unit 24 of the product transaction server 2. This distribution may reduce the amount of data that needs to be transmitted between servers during search operations. The automobile service server 1 may locally access vehicle and user information to acquire category information and part information, and may transmit only the acquired information to the product transaction server 2 for product searching, rather than transmitting raw database records.

In some cases, the separate database architecture may enable specialized database technologies to be used for different data types. For example, the vehicle image DB 14c may utilize a database system optimized for binary large object (BLOB) storage and retrieval, while the product DB 24a may utilize a database system optimized for full-text search operations. The parts DB 14b may utilize a database system that efficiently handles hierarchical relationships, such as the component part lists indicating vehicle parts included within other vehicle parts. By selecting appropriate database technologies for each data type, overall system performance may be improved.

The separate database architecture may also facilitate scalability. As the number of users, vehicles, products, or transactions increases, individual databases may be scaled independently based on their respective growth rates and performance requirements. For example, the product purchase history DB 24b may grow rapidly as users purchase products over time, and may require additional storage capacity or performance optimization, while the vehicle DB 14a may grow more slowly as new vehicle models are introduced. The separation may allow resources to be allocated efficiently based on the specific needs of each database.

The storage unit 24 may further store various programs such as an operating system, a database management system (DBMS), and a product transaction service product transaction service program. The product transaction service program is a program that causes the system controller 21 to execute processing related to the product transaction service. The product transaction service program may be acquired from, for example, another device via the network NW, or may be recorded on a recording medium such as a magnetic tape, an optical disc, or a memory card and read via a drive device.

The communication unit 25 includes, for example, a network interface card or the like. The communication unit 25 is connected to devices other than product transaction service server 2 via the network NW and controls a communication state with the connected devices.

### 1-3. Functional Outline of System Controllers

### 1-3-1. Automobile Service Server

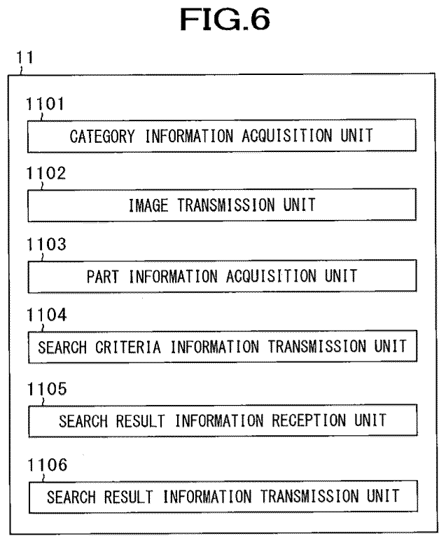

Next, a functional outline of the system controller 11 in the automobile service server 1 will be described with reference to FIGS. 6 to 8B. FIG. 6 is a diagram illustrating an example of functional blocks of the system controller 11 in the automobile service server 1 according to the present embodiment. The system controller 11 may function as a category information acquisition unit 1101, an image transmission unit 1102, a part information acquisition unit 1103, a search criteria information transmission unit 1104, a search result information reception unit 1105, a search result information transmission unit 1106, and the like as illustrated in FIG. 6 by causing the CPU 11a to read and execute various program codes included in the automobile service program.

The category information acquisition unit 1101 may acquire owned vehicle category information indicating a category of a vehicle owned by a user. The user may be, for example, a user who requests a search for vehicle part products from the automobile service server 1. Such a user is referred to as a search-requesting user. Examples of vehicle categories include a vehicle model, a vehicle type identified with the vehicle type designation, a combination of the vehicle model and the grade, a combination of the vehicle type identified with the vehicle type designation and the grade, a combination of the manufacturer and the vehicle model, a combination of the manufacturer, the vehicle model, and the grade, a combination of the vehicle model and model year, and a combination of the vehicle model, the grade, and the model year. The category items indicated by the owned vehicle category information may match the category items indicated by part-compatible vehicle category information. For example, when the owned vehicle category information indicates a vehicle model, the part-compatible vehicle category information may also indicate a vehicle model. The category information acquisition unit 1101 may acquire the owned vehicle category information, for example, from the owned-vehicle DB 14d. Examples of the owned vehicle category information include: a name of a vehicle category; product category information used to identify the vehicle category corresponding to the vehicle part product, among the product categories in a product transaction service; and other information for identifying the vehicle part. For example, a user logs into the automobile service or the product transaction service. When logging in, the user inputs, for example, the user's user ID and the password. The user terminal 3 transmits the input user ID and password to the automobile service server 1 or the product transaction server 2. The server device that receives the user ID and password authenticates the user based on the received information. Upon successful authentication, the server device may cause the user terminal 3 to store a cookie including the user ID. Subsequently, requests transmitted from the user terminal 3 to each of the automobile service server 1 and the product transaction server 2 include the user ID stored in the user terminal 3. The category information acquisition unit 1101 may acquire the owned vehicle category information, for example, from the owned-vehicle information including the user ID transmitted from the user terminal 3.

The image transmission unit 1102 may transmit a vehicle image to the user terminal 3 of the search-requesting user. For example, the image transmission unit 1102 may transmit the vehicle image to be displayed on the user terminal 3. As the vehicle image to be displayed on the user terminal 3, the image transmission unit 1102 may transmit, for example, a vehicle image corresponding to the vehicle category indicated by the owned vehicle category information acquired by the category information acquisition unit 1101. For example, image data of vehicle images for multiple vehicle categories may be stored in the storage unit 14. The vehicle image corresponding to the category indicated by the owned vehicle category information may be a vehicle image of a vehicle belonging to a category that matches the category indicated by the owned vehicle category information among those categories. For example, when the image data of vehicle images are stored for each vehicle model, and the category indicated by the category information indicates the vehicle model. In this case, the image transmission unit 1102 may transmit a vehicle image of a vehicle of the vehicle model indicated by the category information. In some cases, there may be no category among those categories that matches the category indicated by the owned vehicle category information. In such a case, the vehicle image corresponding to the category indicated by the owned vehicle category information may be a vehicle image of a vehicle belonging to a category to which the category indicated by the owned vehicle category information belongs. For example, when the image data of vehicle images are stored for each body type, and the category indicated by the owned vehicle category information indicates the vehicle model. In this case, the image transmission unit 1102 may transmit a vehicle image of a vehicle having the same body type as that of the vehicle model indicated by the owned vehicle category information. In the vehicle database 14a, correspondences among multiple categories having different classification criteria for vehicles are defined. For example, the manufacturer, the vehicle model, the vehicle model designation, the grade, and the body type are associated with one another. By referring to the vehicle DB 14a, the image transmission unit 1102 can identify which category of another item corresponds to the category of a specific item of the user's vehicle.

The image transmission unit 1102 may transmit, to the user terminal 3, a vehicle image corresponding to either the exterior or the interior of the vehicle, whichever has been selected by the search-requesting user. The image transmission unit 1102 may also transmit, to the user terminal 3, a vehicle image viewed from a viewpoint angle corresponding to an operation performed by the search-requesting user among multiple viewpoint angles.

The image transmission unit 1102 may transmit screen information for displaying the vehicle image to the user terminal 3. The image transmission unit 1102 may include, in the screen information, a tag, a script, or a program that allows the user terminal 3 to acquire the vehicle image from the automobile service server 1. Accordingly, the image transmission unit 1102 may transmit the vehicle image in response to a request from the user terminal 3.

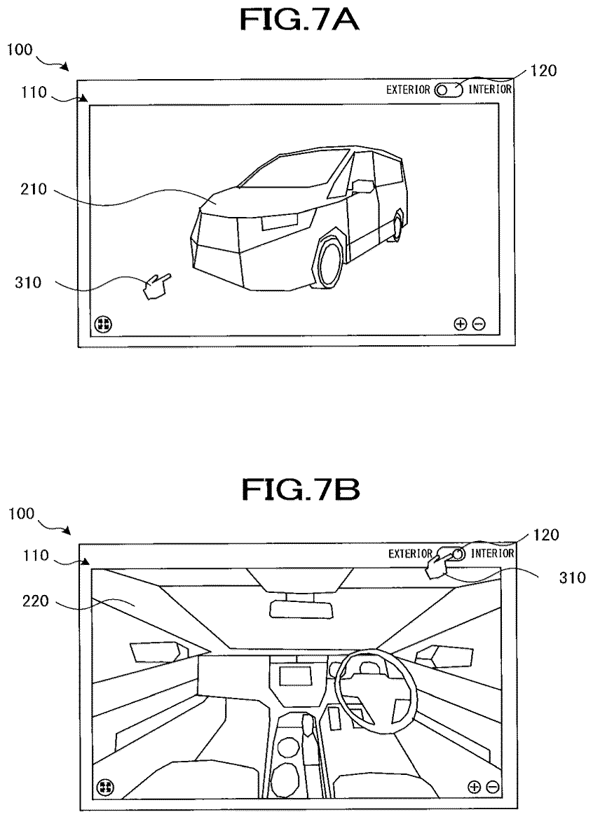

FIG. 7A is a diagram illustrating an example of a part selection screen. The part selection screen is an example of a screen for displaying a vehicle image. As shown in FIG. 7A, the part selection screen 100 may include an image display area 110 and an interior/exterior switching slider 120. The image display area 110 may be an area in which the vehicle image is displayed. For example, as illustrated in FIG. 7A, an exterior image 210 of the vehicle is displayed in the image display area 110. The interior/exterior switching slider 120 may be an operable element for switching the vehicle image displayed in the image display area 110 between an exterior image and an interior image. In addition, a mouse pointer 310 may be displayed on the part selection screen 100. The mouse pointer 310 may be an image indicating a position on the screen. For example, by performing a drag operation in the horizontal direction with the mouse pointer 310, the search-requesting user can change the viewpoint angle of the vehicle image displayed in the image display area 110. The search-requesting user may also be able to move the vehicle image within the image display area 110 upward, downward, leftward, or rightward, or to enlarge or reduce the image. When the user terminal 3 is a terminal device having a touch panel, the mouse pointer 310 may not be displayed, and the search-requesting user may be able to perform operations via the touch panel.

FIG. 7B is a diagram illustrating another example of the part selection screen. In FIG. 7B, elements that are the same as those in FIG. 7A are denoted by the same reference numerals. By moving the mouse pointer 310 to select the interior/exterior switching slider 120, the search-requesting user can switch the vehicle image to an interior image. As a result, as shown in FIG. 7B, an interior image 220 of the vehicle is displayed in the image display area 110.

The part information acquisition unit 1103 may acquire specified-part information for identifying a vehicle part that is located at a position specified by a user operation within the vehicle image displayed on the user terminal 3. The specified-part information may, for example, indicate the type of the vehicle part. Examples of the specified-part information include a part name, a part ID, and a product category ID used in a product transaction service to identify the type of the vehicle part. The position specified by the user operation may be, for example, a position specified by the mouse pointer 310 or a position touched by the search-requesting user's finger on a touch panel. The vehicle part located at the position specified by the user operation may include a vehicle part represented by an image of the specified position within the displayed vehicle image. In addition, the vehicle part located at the position specified by the user operation may include not only a vehicle part directly represented by the image of the specified position but also a vehicle part that is generally included in the portion of the vehicle represented by that image.

The part information acquisition unit 1103 may acquire the coordinates of the specified position. Alternatively, the part information acquisition unit 1103 may cause the user terminal 3 to acquire the coordinates. The coordinates within the vehicle image and the specified-part information may be associated in advance. The information indicating this association may be, for example, the segment map. The part information acquisition unit 1103 may acquire the specified-part information of the vehicle part at the coordinates based on the coordinates of the specified position and the segment map. Alternatively, the part information acquisition unit 1103 may transmit the segment map to the user terminal 3. The part information acquisition unit 1103 may cause the user terminal 3 to acquire the specified-part information of the vehicle part at the coordinates based on the coordinates of the specified position and the segment map. Then, the part information acquisition unit 1103 may acquire the specified-part information from the user terminal 3.

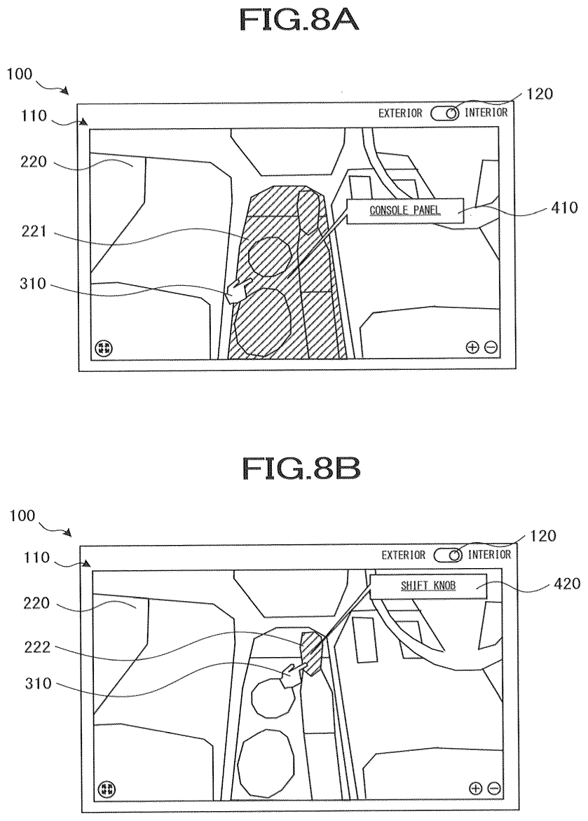

FIG. 8A is a diagram illustrating an example of a part selection screen when a vehicle part is selected. In FIG. 8A, the same elements as in FIG. 7B are denoted by the same reference numerals. For example, the search-requesting user, after enlarging the interior image 220 displayed in the image display area 110 of the part selection screen 100, clicks or specifies the image 221 of the console panel with the mouse pointer 310, as illustrated in FIG. 8A. Then, a part label 410 may be displayed on the part selection screen 100. The part label is a label indicating the vehicle part located at the position specified by the user operation. “Console panel” is displayed on the part label 410. When the search-requesting user clicks or selects the part label 410 with the mouse pointer 310, the user terminal 3 may transmit the specified-part information of the vehicle part indicated by the part label 410 to the automobile service server 1. In the example illustrated in FIG. 8A, the specified-part information indicating the console panel is transmitted.

FIG. 8B is a diagram illustrating another example of the part selection screen when a vehicle part is selected. When the vehicle part located at the position specified by the user operation includes one or more other vehicle parts, an operation for specifying one of the one or more other vehicle parts included in the vehicle part at the specified position may be possible. For example, after the part label 410 is displayed as illustrated in FIG. 8A, the search-requesting user, without selecting the part label 410, clicks or specifies the image 222 of the shift knob within the console panel with the mouse pointer 310, as illustrated in FIG. 8B. Then, a part label 420 may be displayed on the part selection screen 100. “Shift knob” is displayed on the part label 420. When the search-requesting user clicks or selects the part label 420 with the mouse pointer 310, the user terminal 3 may transmit the specified-part information indicating the shift knob.

The search criteria information transmission unit 1104 may transmit the search criteria information to the product transaction server 2. The search criteria information may be information indicating the search criteria for products. The search criteria may be conditions for searching for products. For example, the search criteria information transmission unit 1104 may transmit search criteria information including the owned vehicle category information acquired by the category information acquisition unit 1101 and the specified-part information acquired by the part information acquisition unit 1103.

The search result information reception unit 1105 may receive search result information from the product transaction server 2 which has searched for products based on the search criteria information transmitted by the search criteria information transmission unit 1104. The search result information may be information indicating results of the product search. The search result information may include information on each product that satisfies the search criteria. For example, the search result information may include at least one of a product name, a store name of the seller of the product, a product image URL, a price, product category information for the product, a URL of screen information for the product screen, and review information for the product by users who purchased the product. Further, the search result information may include information indicating the display priority rank for each product. The priority rank may indicate how preferentially the information on the product is displayed. The higher the priority rank, the more preferentially the product information is displayed.

The search result information transmission unit 1106 may transmit search result information indicating the results of the product search by the product transaction server 2 to the user terminal 3. For example, the search result information transmission unit 1106 may transmit the search result information received by the search result information reception unit 1105 as is. Alternatively, as another example of the search result information, the search result information transmission unit 1106 may transmit screen information for a search result screen. The search result screen may be a screen indicating the product search results. Information on each product that satisfies the search criteria may be displayed on the search result screen. For example, the product name, store name, product image, price, product category name, and the like may be displayed. Further, the search result screen may include links to the screen information for the product screens of the products that satisfy the search criteria. For example, when the search-requesting user performs an operation to select information on any product on the search result screen, the user terminal 3 may transmit the URL of the screen information for the product screen of that product to the product transaction server 2. The product transaction server 2 may transmit the screen information associated with this URL to the user terminal 3 of the search-requesting user. The user terminal 3 may display the product screen for the product selected by the search-requesting user based on this screen information. Further, on the search result screen, the information on the products that satisfy the search criteria may be arranged in an order corresponding to the display priority ranks. For example, the product information may be arranged from top to bottom on the search result screen in descending order of priority ranks. The search result information transmission unit 1106 may generate the screen information for the search result screen based on the search result information received by the search result information reception unit 1105. Further, the search result screen may be a screen capable of internally switching between a plurality of screens. For example, the search result screen may include tabs for switching the displayed screen. For example, there may be a normal screen, a category screen, and a review screen. The normal screen may be a screen on which the information on the found products is arranged and displayed according to the priority ranks. The category screen may be a screen on which a list of categories for the found products is displayed. For example, categories to which a relatively large number of the searched products belong may be displayed. When the user selects any category on the category screen, the information on products of the selected category among the found products may be arranged and displayed according to the priority ranks. The review screen may be a screen on which reviews for the found products are displayed.

### 1-3-2. Product Transaction Server

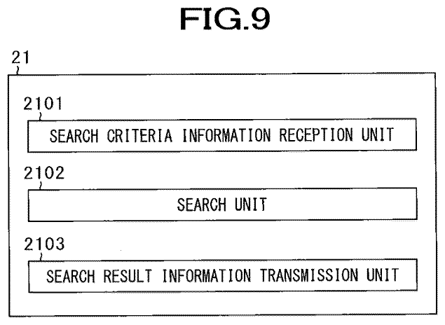

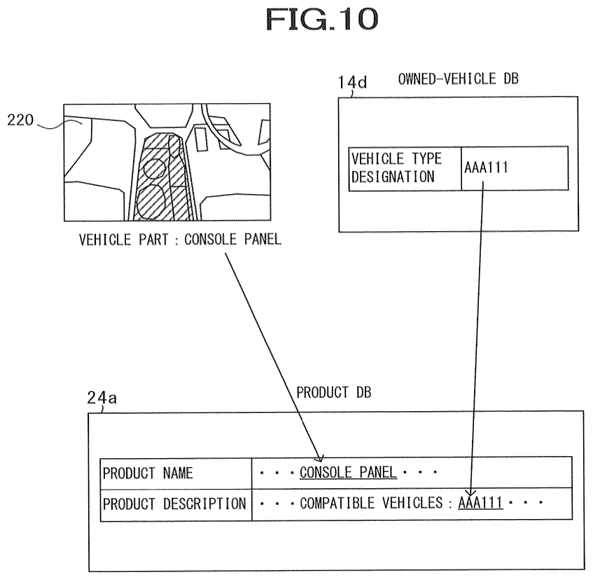

Next, a functional overview of the system controller 21 in the product transaction server 2 will be described with reference to FIGS. 9 and 10. FIG. 9 is a diagram illustrating an example of functional blocks of the system controller 21 in the product transaction server 2 according to the present embodiment. The system controller 21, by the CPU 21a reading and executing various program codes included in the product transaction service program, may function as a search criteria information reception unit 2101, a search unit 2102, a search result information transmission unit 2103, and the like, as illustrated in FIG. 9.

The search criteria information reception unit 2101 may receive the search criteria information transmitted from the automobile service server 1.

The search unit 2102 may search for products by referencing the product information storage means. The product information storage means may be the product DB 24a or the storage unit 24. The search unit 2102 may use the owned vehicle category information acquired by the category information acquisition unit 1101 of the automobile service server 1 and the specified-part information acquired by the part information acquisition unit 1103 of the automobile service server 1 as search criteria. The search unit 2102 may search for products that satisfy both conditions of the owned vehicle category information and the specified-part information. For example, the search unit 2102 may search for products whose product information includes both the owned vehicle category information and the specified-part information. As described above, the product information for at least one product among vehicle part products includes part-compatible vehicle category information and product part information. The search unit 2102 may search for product information that includes part-compatible vehicle category information matching the owned vehicle category information and product part information matching the specified-part information. Thereby, it is possible to search for a product of a vehicle part that is compatible with the vehicle of the category indicated by the owned vehicle category information and is the part indicated by the specified-part information. Alternatively, it is possible to search for a product that is highly probable to be a vehicle part compatible with the vehicle of that category and is the vehicle part indicated by the specified-part information. This owned vehicle category information and specified-part information are included in the search criteria information received by the search criteria information reception unit 2101.

Assume that the product information stored in the product information storage means includes text regarding the product. In this case, the search unit 2102 may use the name of the category indicated by the owned vehicle category information as a keyword and search for products whose product information text includes that keyword. Further, the search unit 2102 may use the name of the vehicle part indicated by the specified-part information as a keyword and search for products whose product information text includes that keyword. That is, the search unit 2102 may perform a keyword search. Examples of text regarding the product include a product name, a catchphrase, and a product description. The search unit 2102 may perform the search using any one, two, or all of the product name, the catchphrase, and the product description.

When a category of the vehicle with which the vehicle part is compatible exists as a product category for vehicle parts, the search unit 2102 may search for products for which the product category information included in the product information indicates that the product belongs to the category indicated by the owned vehicle category information. For example, the search unit 2102 may search for products whose product category information includes a product category ID corresponding to the vehicle category indicated by the owned vehicle category information. Further, when a category identifiable by the general name of the vehicle part or a category indicating the type of vehicle part exists as a product category for vehicle parts, the search unit 2102 may search for products for which the product category information included in the product information indicates that the product is the vehicle part indicated by the specified-part information. For example, the search unit 2102 may search for products whose product category information includes a product category ID corresponding to the vehicle part indicated by the specified-part information.

When the product information for a vehicle part product includes attribute information indicating the category of the vehicle with which the vehicle part is compatible, the search unit 2102 may search for products for which the attribute information included in the product information indicates the category shown by the owned vehicle category information.

Further, the search unit 2102 may search for products that satisfy the search criteria from, for example, products in categories related to automobiles. For example, the search unit 2102 may perform a search from among car accessory products.

FIG. 10 is a diagram illustrating an example of a product search. For example, as illustrated in FIG. 10, the search-requesting user specified the console panel in the vehicle interior image 220 displayed on the part selection screen 100. Further, the owned-vehicle information for the search-requesting user stored in the owned-vehicle DB 14d includes the vehicle type designation “AAA111” of the vehicle owned by the search-requesting user. In this case, the keyword “console panel” as the specified-part information and the keyword “AAA111” as the owned vehicle category information may be used as search criteria. For example, the product name of a certain product includes the keyword “console”. Further, the product description for that product includes the keyword “AAA111”. Therefore, the search unit may identify that product as one of the products satisfying the search criteria. Note that, as described above, the vehicle category is not limited to the vehicle type identified with the vehicle type designation.

The search result information transmission unit 2103 may transmit the search result information which indicates the results of the product search by the search unit 2102, to the automobile service server 1. For example, the search result information transmission unit 2103 may generate the search result information based on the product information for each found product. The search result information transmission unit 2103 may determine the priority rank for each product found by the search unit 2102. This priority rank may indicate how preferentially the presentation or display of each searched product is performed. The higher the priority rank of a product, the more preferentially the information on that product may be displayed. The search result information transmission unit 2103 may determine the priority rank based on a predetermined criterion. For example, the search result information transmission unit 2103 may set the priority rank higher as the popularity level of the product is higher. The popularity level may indicate how popular the product is. For example, the popularity level may be determined based on the number of purchases or the frequency of purchases of the product. For example, the popularity level of the product may become higher as the number of purchases of that product increases. For example, the search result information transmission unit 2103 may determine the number of purchases or the frequency of purchases for each product based on the product purchase history DB 24b. The search result information transmission unit 2103 may determine the popularity level for each product in advance. The search result information transmission unit 2103 may, for example, include the determined popularity level for each product in the product information stored in the product DB 24a. The search result information transmission unit 2103 may include the determined priority rank for each product in the search result information. Further, the search result information transmission unit 2103 may acquire review information from users for each product from a predetermined database (not shown). The search result information transmission unit 2103 may include the review information in the search result information.

### 1-4. Operation of Communication System

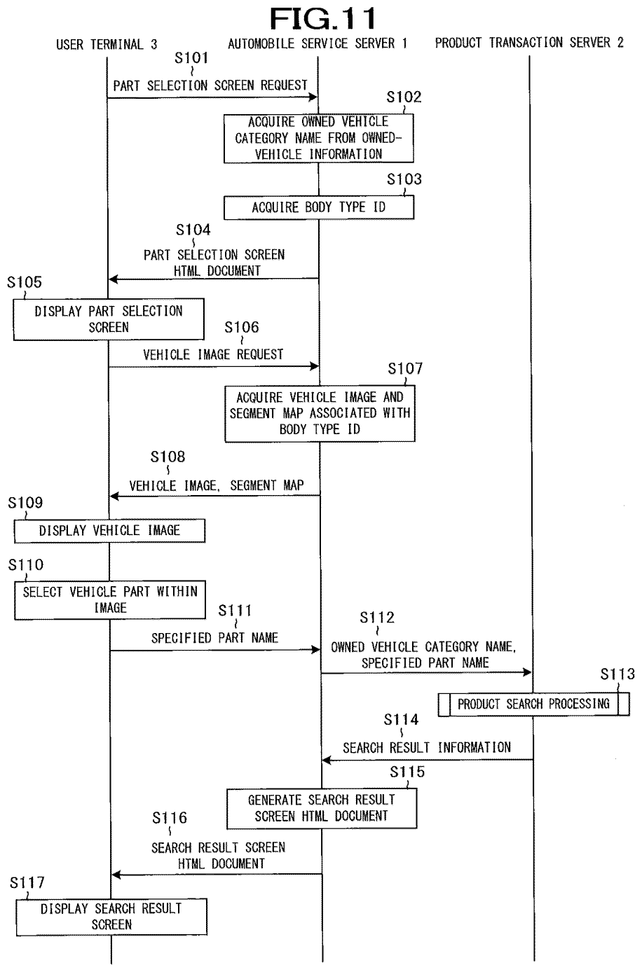

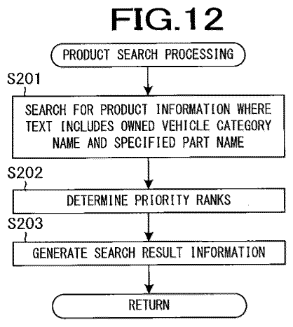

Next, the operation of the communication system S will be described with reference to FIGS. 11 and 12. The system controller 11 of the automobile service server 1 may execute the processing illustrated in FIG. 11 according to various program codes included in the automobile service program. The system controller 21 of the product transaction server 2 may execute the processing illustrated in FIGS. 11 and 12 according to various program codes included in the product transaction service program. The order of the processing is not limited to the order illustrated in these figures. Further, at least one of the steps illustrated in these figures may not be executed.

FIG. 11 is a sequence diagram illustrating an example of processing by the communication system S according to the present embodiment. For example, some screen of the automobile service is displayed on the user terminal 3. Here, the search-requesting user performs an operation to select a search for vehicle part products. In response to this operation, the user terminal 3 transmits a part selection screen request to the automobile service server 1, as illustrated in FIG. 11 (Step S101). The part selection screen request may indicate a request for screen information for the part selection screen. The category information acquisition unit 1101 of the automobile service server 1 acquires, from the owned-vehicle information stored in the owned-vehicle DB 14d in association with the user ID included in the part selection screen request, an owned vehicle category name indicating the name of the category of the vehicle owned by the search-requesting user, as an example of the owned vehicle category information (Step S102). For example, the category information acquisition unit 1101 may acquire the respective names for one or more predetermined items of the category. Next, the image transmission unit 1102 acquires the body type ID, which is associated with the vehicle type designation included in this owned-vehicle information, from the vehicle DB 14a (Step S103). Next, the image transmission unit 1102 transmits an HTML document, as an example of the screen information for the part selection screen, to the user terminal 3 (Step S104). The user terminal 3 displays the part selection screen 100 based on this HTML document (Step S105).

Further, the user terminal 3 transmits a vehicle image request to the automobile service server 1 according to the tags, script, or program included in this HTML document (Step S106). The vehicle image request may indicate a request for a vehicle image. The vehicle image request may include, for example, an interior/exterior type indicating exterior and a viewpoint angle indicating 0 degrees. The image transmission unit 1102 of the automobile service server 1, which has received the vehicle image request, acquires the image data of the vehicle image and the segment map associated with the acquired body type ID from the storage unit 14 (Step S107). For example, the image transmission unit 1102 may acquire a vehicle image URL and a segment map URL associated with the combination of the body type ID, the exterior type included in the vehicle image request, and the viewpoint angle, from the vehicle image DB 14c. The image transmission unit 1102 may acquire the image data of the vehicle image and the segment map associated respectively with the acquired vehicle image URL and segment map URL. Next, the image transmission unit 1102 transmits the acquired image data and segment map to the user terminal 3 (Step S108). The user terminal 3, which has received the image data and segment map, displays the vehicle image in the screen area 110 based on this screen information (Step S109). Thereafter, Steps S106 to S109 may be executed in response to operations by the user for switching the vehicle interior/exterior or for changing the viewpoint angle.

After Step S109, the search-requesting user performs an operation to select a vehicle part from the displayed vehicle image (Step S110). For example, the search-requesting user performs an operation to specify a certain position within the vehicle image. The part selection screen HTML document may describe an event handler for specifying within the vehicle image. According to this event handler, the user terminal 3 may identify the coordinates of the specified position. The user terminal 3 may acquire the parts ID corresponding to the coordinates of the specified position from the segment map. The user terminal 3 may display a part label including the part name of the vehicle part identified by the parts ID. The search-requesting user selects the vehicle part by selecting the displayed part label (Step S110). In response to the selection of the vehicle part, the user terminal 3 transmits the part name of the selected vehicle part, as the specified part name, to the automobile service server 1 (Step S111). The search criteria information transmission unit 1104 of the automobile service server 1 transmits search criteria information, including the acquired vehicle category name and the received specified part name, to the product transaction server 2 (Step S112). The product transaction server 2, which has received the vehicle category name and the specified part name, executes product search processing (Step S113).

FIG. 12 is a flowchart illustrating an example of the product search processing executed by the system controller 21 of the product transaction server 2 according to the present embodiment. As illustrated in FIG. 12, the search unit 2102 searches the product DB 24a for product information that includes the vehicle category name received from the automobile service server 1 in any of one or more predetermined types of text, and that also includes the specified part name received from the automobile service server 1 in any of one or more predetermined types of text (Step S201). The one or more predetermined types of text may be one or more predetermined pieces of information among the product name, catchphrase, and product description. Next, the search result information transmission unit 2103 determines the display priority ranks for the products corresponding to each found product information (Step S202). Next, the search result information transmission unit 2103 generates search result information based on the found product information (Step S203). For example, the search result information transmission unit 2103 may generate search result information including the product name, product image URL, price, URL of the screen information for the product screen, priority rank, and the like, for each product. When Step S203 ends, the product search processing ends.

Returning to FIG. 11, when the product search processing ends, the search result information transmission unit 2103 transmits the generated search result information to the automobile service server 1 (Step S114). The search result information transmission unit 1106 of the automobile service server 1 generates an HTML document, as an example of the screen information for the search result screen, based on the search result information (Step S115). For example, the search result information transmission unit 1106 may generate information for displaying the product name, product image, price, and the like, for each product. The search result information transmission unit 1106 may add the information for each generated product to the HTML document for the search result screen such that the information for each product is arranged from top to bottom in accordance with the priority ranks. Next, the search result information transmission unit 1106 transmits the generated HTML document to the user terminal 3 (Step S116). The user terminal 3 displays the search result screen based on this HTML document (Step S117).

As explained above, according to the present embodiment, the user performs an operation to specify a position where an image of any vehicle part exists within the displayed vehicle image. Then, a product search is performed using, as search criteria, information indicating the category of the vehicle owned by the user and information identifying the vehicle part at the specified position. Then, information indicating the results of the search is transmitted to the user's terminal device. Therefore, it is possible to search for a product of a vehicle part that is likely to be the vehicle part located at the position specified by the user and is a product of a vehicle part that is likely to compatible with the vehicle owned by the user. Accordingly, it is possible to search for a product of a vehicle part suited to the vehicle owned by the user, based on an operation on the image.

Here, the automobile service server 1 may acquire the owned vehicle category information based on owned-vehicle information indicating the vehicle owned by the user and registered in advance by the user. In this case, since the information on the vehicle owned by the user is registered in advance, the category of the vehicle owned by that user can be identified based on that information.

Further, the automobile service server 1 may transmit, as the image to be displayed on the user terminal 3, an image of a vehicle corresponding to the category indicated by the owned vehicle category information, to the user terminal 3. In this case, an image of the vehicle corresponding to the category of the vehicle owned by the user is displayed. Therefore, the user can specify a vehicle part from an image suited to the vehicle owned by that user.

### 2. Second Embodiment

Next, a second embodiment will be described. Except for the points described below, the present embodiment may be the same as the first embodiment. In the first embodiment, the automobile service server 1 acquired the owned vehicle category information for the vehicle owned by the search-requesting user from information registered by the search-requesting user. The automobile service server 1 of the present embodiment acquires the owned vehicle category information based on the purchase history of vehicles. In the present embodiment, the vehicle purchased by the search-requesting user may be regarded as the vehicle owned by that search-requesting user.

### 2-1. Configuration of Automobile Service Server

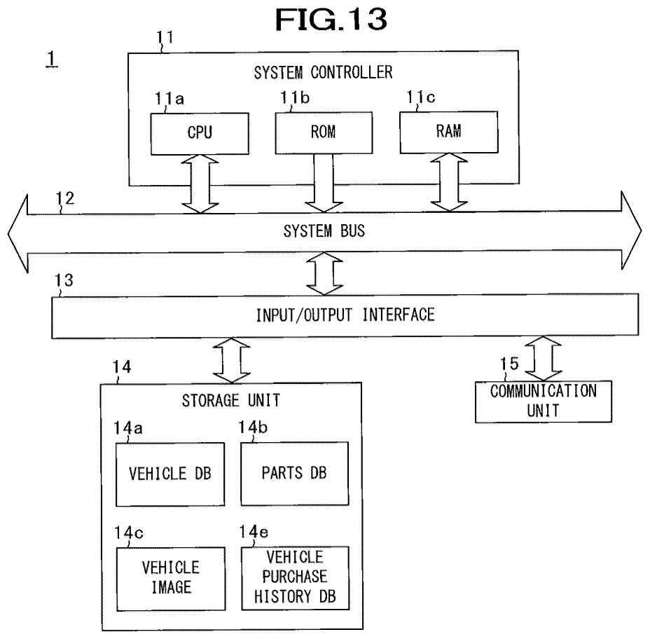

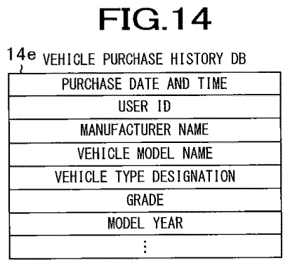

Next, the configuration of the automobile service server 1 will be described with reference to FIGS. 13 and 14. FIG. 13 is a block diagram illustrating an example of a schematic configuration of the automobile service server 1 according to the present embodiment. In FIG. 13, the same elements as in FIG. 2 are denoted by the same reference numerals. FIG. 13 differs from FIG. 2 in that the storage unit 14 stores a vehicle DB 14a, a parts DB 14b, a vehicle image DB 14c, and a vehicle purchase history DB 14e.

FIG. 14 is a diagram illustrating an example of information stored in the databases in the automobile service server 1. The vehicle purchase history DB 14e may store vehicle purchase history information indicating the history of vehicle purchases through the automobile service. For example, a vehicle purchase log may be stored in the vehicle purchase history DB 14e each time a vehicle is purchased. The vehicle purchase log may be information indicating a record of a vehicle purchase. For example, as illustrated in FIG. 14, the vehicle purchase history DB 14e may store, as the vehicle purchase log, a purchase date and time, a user ID, a manufacturer name, a vehicle model name, a vehicle type designation, a grade, a model year, and the like, in association with each other. The purchase date and time may indicate a date and time when a vehicle was purchased. The user ID may indicate a user who purchased the vehicle. Each of the manufacturer name, vehicle model name, vehicle type designation, grade, and model year may indicate a category of the purchased vehicle. That is, the manufacturer name may be the name of the manufacturer of the vehicle. The vehicle model name may indicate the name of the model of the vehicle. The vehicle type designation may be a code indicating the type of the vehicle. The grade may indicate the class of the vehicle. The model year may indicate the year in which the vehicle was manufactured.

2-2. Functional Overview of System controller of Automobile Service Server

Next, a functional overview of the system controller 11 in the automobile service server 1 will be described. The category information acquisition unit 1101 may acquire the owned vehicle category information based on vehicle purchase history information indicating the history of vehicle purchases by the search-requesting user. For example, the category information acquisition unit 1101 may search the vehicle purchase history DB 14e for one or more vehicle purchase logs that include the user ID of the search-requesting user acquired from the user terminal 3, as the vehicle purchase history information for that search-requesting user. The category information acquisition unit 1101 may acquire owned vehicle category information indicating the category of the vehicle indicated by the searched vehicle purchase logs. For example, the category information acquisition unit 1101 may acquire, as the owned vehicle category information, one or more predetermined pieces of information among the manufacturer name, vehicle model name, vehicle type designation, grade, and model year included in the vehicle purchase log. When multiple vehicle purchase logs are found, the category information acquisition unit 1101 may acquire the owned vehicle category information based on the vehicle purchase log that includes the most recent purchase date and time among those vehicle purchase logs. That is, the last purchased vehicle may be regarded as the vehicle currently owned by the user.

2-3. Operation of Communication System

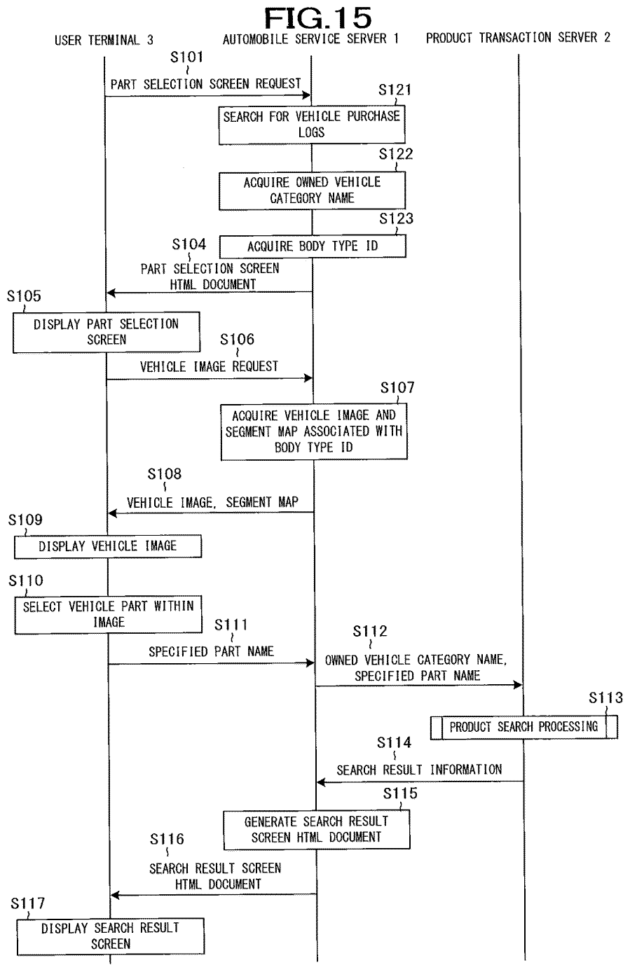

Next, the operation of the communication system S will be described with reference to FIG. 15. FIG. 15 is a sequence diagram illustrating an example of processing by the communication system S according to the present embodiment. In FIG. 15, the same processing as in FIG. 11 is denoted by the same reference numerals. As illustrated in FIG. 15, upon receiving the part selection screen request from the user terminal 3 (Step S101), the category information acquisition unit 1101 of the automobile service server 1 searches the vehicle purchase history DB 14e for a vehicle purchase log including the user ID included in the part selection screen request (Step S121). Next, the category information acquisition unit 1101 acquires an owned vehicle category name, as an example of the owned vehicle category information, from the found vehicle purchase log (Step S122). Next, the image transmission unit 1102 acquires the body type ID stored in the vehicle DB 14a in association with the model name included in the found vehicle purchase log (Step S123). Thereafter, Steps S104 to S117 are executed.

As explained above, according to the present embodiment, the owned vehicle category information is acquired based on information indicating the vehicle purchase history by the user. It is highly probable that the vehicle purchased by the user is the vehicle owned by that user. Therefore, the category of the vehicle owned by that user can be identified based on the information indicating the vehicle purchase history.

### 3. Third Embodiment

Next, a third embodiment will be described. Except for the points described below, the present embodiment may be the same as at least one of the embodiments described so far. In the present embodiment, a vehicle part product compatible with a vehicle of the category of the vehicle owned by the search-requesting user is searched for, and, in some cases, a vehicle part product compatible with a vehicle of a category different from that category is searched for. The product which is searched for may be a product that is potentially compatible with the vehicle owned by the search-requesting user.

### 3-1. Configuration of Automobile Service Server

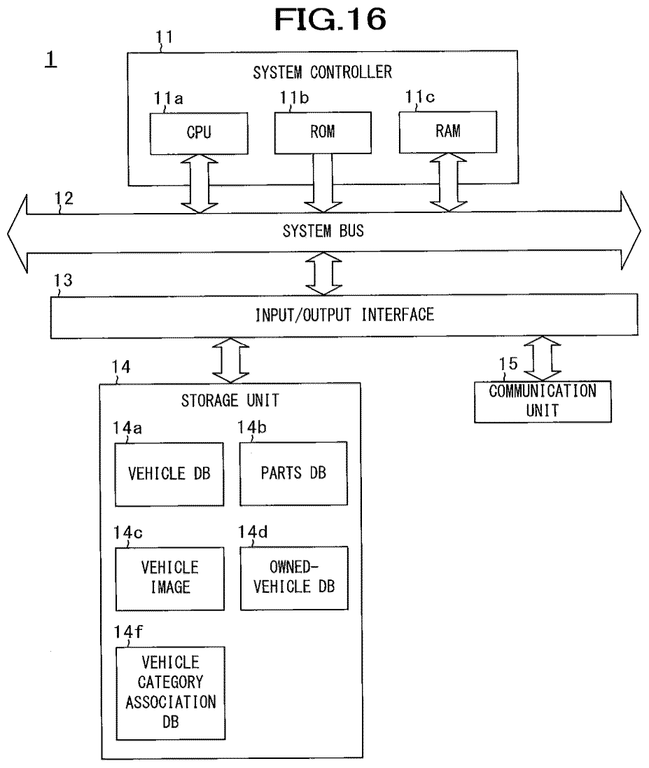

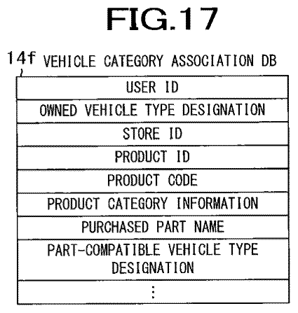

Next, the configuration of the automobile service server 1 will be described with reference to FIGS. 16 and 17. FIG. 16 is a block diagram illustrating an example of a schematic configuration of the automobile service server 1 according to the present embodiment. In FIG. 16, the same elements as in FIG. 2 are denoted by the same reference numerals. FIG. 16 differs from FIG. 2 in that the storage unit 14 stores, in addition to the vehicle DB 14a, the parts DB 14b, the vehicle image DB 14c, and the owned-vehicle DB 14d, a vehicle category association DB 14f.

FIG. 17 is a diagram illustrating an example of information stored in the databases in the automobile service server 1. The vehicle category association DB 14f may store vehicle category association information each time a user, who is considered to own a vehicle, purchases a vehicle part product. The vehicle category association information may be information indicating an association between the category of the vehicle owned by the user and the category of the vehicle with which the vehicle part purchased by the same user is compatible. As described above, the category of the vehicle owned by the user is referred to as the owned vehicle category. Further, the category of the vehicle with which the vehicle part is compatible is referred to as the part-compatible vehicle category. The items for the owned vehicle category and the items for the part-compatible vehicle category may be the same. The owned vehicle category and the part-compatible vehicle category may have categories positioned in their upper hierarchical layers. A category positioned in the upper hierarchical layer of each of the owned vehicle category and the part-compatible vehicle category is referred to as an upper category. The upper category of the owned vehicle category encompasses multiple categories including that owned vehicle category. Further, the upper category encompasses multiple categories including that part-compatible vehicle category. Examples of general upper categories are listed below. A category of manufacturer is an upper category of vehicle model. A category of vehicle model is an upper category of each of vehicle type designation, grade, and model year. A category of vehicle type identified with a vehicle type designation is an upper category of each of grade and model year. A category of grade is an upper category of model year. Further, the upper category of the upper category of a certain category may also be an upper category of that category. Each of the owned vehicle category and the part-compatible vehicle category may be a combination of a plurality of categories. For example, when the upper category is a category of vehicle model, examples of the owned vehicle category and the part-compatible vehicle category include a category of vehicle type identified with a vehicle type designation of the vehicle of that model, a category of grade of the vehicle of that model, a combination of categories of vehicle type designation and a category of grade, and a combination of categories of vehicle type designation, grade, and model year. The owned vehicle category and the part-compatible vehicle category indicated by the vehicle category association information may be different categories. The vehicle category association information may include the owned vehicle category information and the part-compatible vehicle category information. The owned vehicle category information is information indicating the owned vehicle category. The part-compatible vehicle category information is information indicating the part-compatible vehicle category. Further, the vehicle category association information may include purchased-part information. The purchased-part information may be information for identifying the purchased vehicle part. As illustrated in FIG. 17, the vehicle category association DB 14f may store, as the vehicle category association information, a user ID, an owned vehicle type designation, a store ID, a product ID, a product code, product category information, a purchased part name, a part-compatible vehicle type designation, and the like, in association with each other. The user ID may indicate a targeted user. The owned vehicle type designation may be a vehicle type designation indicating a type of the vehicle owned by that user. The owned vehicle type designation is an example of the owned vehicle category information. The store ID may indicate the seller of the part purchased by that user. The product ID may indicate the product purchased by that user from that store. The product code may indicate the purchased product. The product category information may indicate the category of the purchased product. The purchased part name may be a general name of the purchased vehicle part or a name indicating the type of that vehicle part. The purchased vehicle part name is an example of the purchased-part information. The part-compatible vehicle type designation may be a vehicle type designation indicating a type of the vehicle with which the purchased product is compatible. The part-compatible vehicle type designation is an example of the part-compatible category information.

3-2. Functional Overview of System controller

### 3-2-1. Automobile Service Server

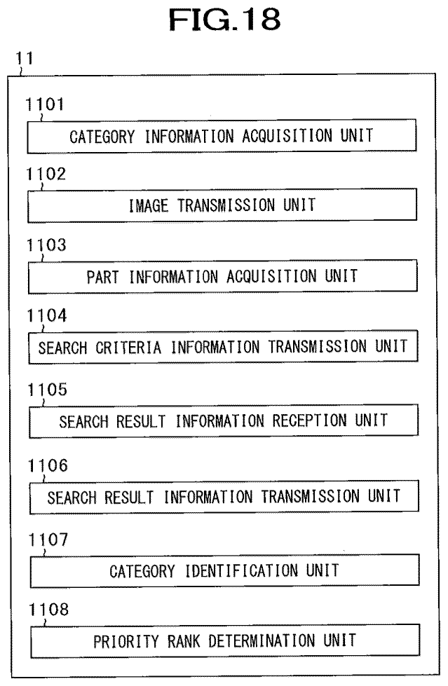

Next, a functional overview of the system controller 11 in the automobile service server 1 will be described with reference to FIGS. 18 to 20. FIG. 18 is a diagram illustrating an example of functional blocks of the system controller 11 in the automobile service server 1 according to the present embodiment. In FIG. 18, the same elements as in FIG. 6 are denoted by the same reference numerals. As illustrated in FIG. 18, the system controller 11 may function as a category identification unit 1107 and a priority rank determination unit 1108, in addition to the category information acquisition unit 1101 to the search result information transmission unit 1106.

The category identification unit 1107 may identify, in association, the owned vehicle category, which is the category of the vehicle owned by the user, and the part-compatible vehicle category, which is the category of the vehicle with which the vehicle part purchased by that user is compatible. Further, the category identification unit 1107 may identify the owned vehicle category of the vehicle owned by the user, the part-compatible vehicle category with which the part purchased by that user is compatible, and the purchased part. For example, the category identification unit 1107 may perform the identification based on the owned vehicle category information for a plurality of users, product purchase history information, and product information. The owned vehicle category information to be used may be information indicating the categories of the vehicles owned respectively by the plurality of users. These plurality of users may be users who own vehicles. These plurality of users may or may not include the search-requesting user. For example, the category information acquisition unit 1101 can acquire the owned vehicle category information for each user who owns a vehicle. The product purchase history information may be information indicating the purchase history of vehicle part products. The product purchase history information to be used may be information indicating the purchased product and the user who purchased that product. For example, one or more purchase logs indicating records of vehicle part product purchases, among the purchase logs stored in the product DB 24a, can be acquired as the product purchase history information. The product information to be used may be product information for the product indicated by the product purchase history information as the purchased vehicle part product. As described above, the product information for a vehicle part product may include product part information and part-compatible vehicle category information.

The category information acquisition unit 1101 may acquire, for example, the user ID of each user who owns a vehicle and the owned vehicle category information indicating the category of the vehicle owned by the respective that user, based on the owned-vehicle information or the vehicle purchase history information. Thereby, the category of the vehicle owned by the user is identified. The category identification unit 1107 may search the product purchase history DB 24b for product purchase logs including the acquired user ID. At this time, the category identification unit 1107 may search for purchase logs for vehicle part products. For example, based on the product category information included in the product information of the purchased product, purchase logs for products in the car accessories category may be searched for as the purchase logs for vehicle part products. Alternatively, the category identification unit 1107 may search for purchase logs for products in each category that is a sub-category of the car accessories category and corresponds to vehicle parts. The category identification unit 1107 may cause the product transaction server 2 to execute the search for product purchase logs. The category identification unit 1107 may acquire the product information for the product indicated by the product ID included in the product purchase log from the product DB 24a. The category identification unit 1107 may acquire the part-compatible vehicle category information from the acquired product information. Furthermore, the category identification unit 1107 may acquire the product part information included in the product information as the purchased-part information.

The category identification unit 1107 may store the results of the identification, regarding the category of the vehicle owned by the user and the category of the vehicle with which the vehicle part purchased by that user is compatible, in the storage unit 14. Furthermore, the category identification unit 1107 may store the results of the identification of the purchased vehicle part in the storage unit 14. The information indicating the results of this identification may be the vehicle category association information. The category identification unit 1107 may store the owned vehicle category information, the acquired part-compatible vehicle category information, and the purchased-part information, acquired for the same user, in the vehicle category association DB 14f in association with each other. When the owned vehicle category information and the part-compatible vehicle category information indicate the same category, the category identification unit 1107 does not need to store the vehicle category association information for them.

The search criteria information transmission unit 1104 may transmit, as the search criteria information, first search criteria information and second search criteria information to the product transaction server 2. By transmitting the two sets of search criteria information, the search criteria information transmission unit 1104 may cause the product transaction server 2 to search for products using mutually different search criteria. The first search criteria information may be information indicating the first search criteria for products. The second search criteria information may be information indicating the second search criteria for products. Each of the first search criteria information and the second search criteria information may include the specified-part information acquired by the part information acquisition unit 1103. The first search criteria information may include, in addition to the specified-part information, first vehicle category information indicating a first vehicle category which is the category including the vehicle owned by the search-requesting user, as the vehicle category information. That is, the first search criteria information may be the same as the search criteria information described in the first embodiment, etc. The first vehicle category may correspond to the owned vehicle category of the search-requesting user. Thereby, the product transaction server 2 will search, based on the first search criteria information, for products of a vehicle part that is located at the position specified by the search-requesting user within the vehicle image and is compatible with a vehicle of the first vehicle category, which is the same as the category of the vehicle owned by the search-requesting user. The second search criteria information may include, in addition to the specified-part information, second vehicle category information indicating a second vehicle category which is different from the first vehicle category, as the vehicle category information. The upper category of the first vehicle category and the upper category of the second vehicle category may be the same. That is, each of the first vehicle category and the second vehicle category may be one of multiple categories included in the same upper category. For example, when the first vehicle category is a category of type identified with a vehicle type designation of the vehicle owned by the search-requesting user, the second vehicle category may be a category of type identified with a vehicle type designation of a vehicle of the same vehicle model as that of the vehicle owned by the search-requesting user but different from the category of type identified with the vehicle type designation of the vehicle owned by the search-requesting user. Thereby, the product transaction server 2 will search, based on the second search criteria information, for products of a vehicle part that is located at the position specified by the search-requesting user within the vehicle image and is compatible with a vehicle of the second vehicle category which is different from the category of the vehicle owned by the search-requesting user but is among the categories included in the same upper category as the upper category that includes the first vehicle category of the vehicle owned by the search-requesting user. Although the vehicle of the second vehicle category is different from the vehicle of the first vehicle category, the vehicle of the first vehicle category and the vehicle of the second vehicle category are vehicles of the same upper category. Therefore, the vehicle part compatible with the vehicle of the second vehicle category may potentially compatible with the vehicle of the first vehicle category. Thus, it is possible to search for vehicle part products potentially compatible with the vehicle owned by the search-requesting user. On the other hand, if the category of the vehicle with which the vehicle part is compatible is different, the characteristics of that vehicle part may also be different. An example of a characteristic is the design of the vehicle part. Therefore, it is possible to search for vehicle part that are potentially compatible with the vehicle owned by the search-requesting user and are vehicle parts that may have characteristics different from the vehicle parts that normally compatible with the vehicle owned by the search-requesting user.

The search criteria information transmission unit 1104 may determine, based on the identification results by the category identification unit 1107, the second vehicle category to be used as the second search criteria, from among the second vehicle categories different from the first vehicle category. For example, the search criteria information transmission unit 1104 may determine, as the second vehicle category information to be used for the search, information indicating a category that is identified by the category identification unit 1107 as the category of a vehicle with which a vehicle part purchased by a user who owns a vehicle of the first vehicle category is compatible, from among the second vehicle categories. Therefore, the second vehicle category may correspond to the part-compatible vehicle category of the purchased vehicle part. For example, the search criteria information transmission unit 1104 may acquire, from the category association information indicating the identification results by the category identification unit 1107, the part-compatible vehicle category information indicating the category of the vehicle with which a vehicle part purchased by a user who owns a vehicle of the first vehicle category is compatible, from among the second vehicle categories different from the first vehicle category. As described above, the first vehicle category is compatible to the owned vehicle category. Therefore, the search criteria information transmission unit 1104 may search the vehicle category association DB 14f for vehicle category association information including the same owned vehicle category information as the first vehicle category information acquired by the category information acquisition unit 1101. The search criteria information transmission unit 1104 may acquire the part-compatible vehicle category information included in the found vehicle category association information as the second vehicle category information. Thereby, the product transaction server 2 will search for products of vehicle parts that are compatible with a vehicle of the same category as the category of the vehicle compatible with a vehicle part that has been purchased by some user, among other categories included in the same upper category as the upper category that includes the category of the vehicle owned by the search-requesting user. Even if the product information does not indicate that the vehicle part is compatible with a vehicle of the same category as the category of the vehicle owned by the user, the vehicle part purchased by that user potentially is compatible with the vehicle owned by that user. In that case, the vehicle of the category owned by the user and the vehicle of the category indicated by the product information as the category of the vehicle compatible with the purchased vehicle part may be interchangeable regarding usable vehicle parts. Therefore, it is possible to search for products of vehicle parts that potentially are compatible with the vehicle owned by the user. The search criteria information transmission unit 1104 may acquire, for example, information indicating the category of the vehicle compatible with a vehicle part whose purchase count or purchase frequency is equal to or greater than a predetermined value, as the second vehicle category information.

The search criteria information transmission unit 1104 may determine, as the second vehicle category information to be used as the second search criteria, information indicating the category of the vehicle compatible with a vehicle part that is the same as the vehicle part indicated by the specified-part information acquired by the part information acquisition unit 1103, among the vehicle parts purchased by users who own vehicles of the first category. Thereby, the product transaction server 2 will search for a products of vehicle parts compatible with a vehicle of the same category as the category of the vehicle compatible with a vehicle part that is of the same type as the vehicle part located at the position specified by the search-requesting user within the vehicle screen and has been purchased by some user, among other categories included in the same upper category as the upper category that includes the category of the vehicle owned by the search-requesting user. Thereby, it is possible to search for products of vehicle parts, of the type specified by the search-requesting user, that potentially are compatible with the vehicle owned by the search-requesting user. Whether or not there is compatibility of usable vehicle parts between vehicles of mutually different categories may vary depending on the type of vehicle part. When the vehicle category association information includes the purchased-part information, the search criteria information transmission unit 1104 may acquire the part-compatible vehicle category information as the second vehicle category information from the vehicle category association information that includes purchased-part information matching the specified-part information.

The search result information reception unit 1105 may receive, from the product transaction server 2, first search result information indicating the results of the search by the product transaction server 2 based on the first search criteria information transmitted by the search criteria information transmission unit 1104. Products found based on the first search result information are referred to as first products. Further, the search result information reception unit 1105 may receive, from the product transaction server 2, second search result information indicating the results of the search by the product transaction server 2 based on the second search criteria information transmitted by the search criteria information transmission unit 1104. Products found based on the second search result information are referred to as second products.

The priority rank determination unit 1108 may determine the priority ranks for the products found by the product transaction server 2. This priority rank may indicate how preferentially the presentation or display of each searched product is performed. The higher the priority rank of a product, the more preferentially the information on that product may be displayed. The priority rank determination unit 1108 may set the priority ranks of the second products higher than the priority ranks of the first products. Thereby, it is possible to preferentially present to the search-requesting user vehicle parts that may have characteristics different from the vehicle parts that normally compatible with the vehicle owned by the search-requesting user.

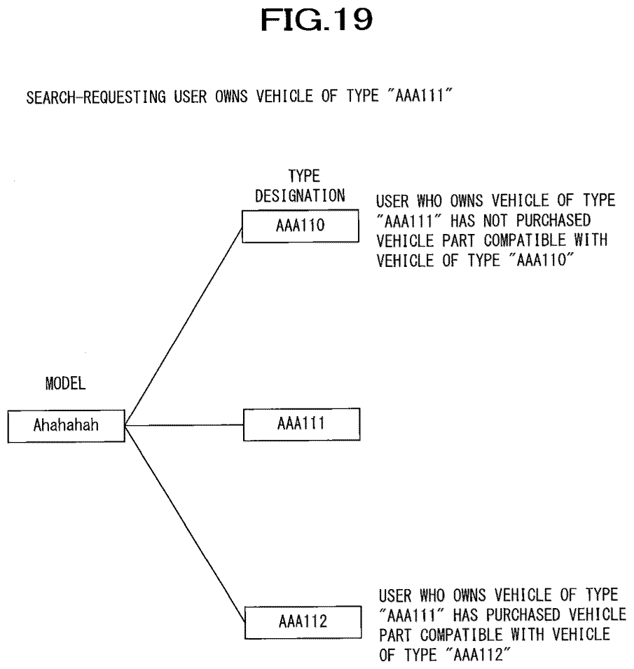

FIG. 19 is a diagram illustrating an example of vehicle categories and vehicle part purchase status. For example, the upper category may be a category of vehicle model, and each of the first vehicle category and the second vehicle category may be a category of vehicle type identified with the type designation of the vehicle. As illustrated in FIG. 19, the search-requesting user owns a vehicle of type designation “AAA111”. The vehicle of this type is a vehicle of vehicle model name “Ahahahah”. As vehicles of vehicle model name “Ahahahah”, there are vehicles of a type designation “AAA110” and vehicles of type designation “AAA112”, in addition to the vehicle of type designation “AAA111”. Assume that users other than the search-requesting user own vehicles of type designation “AAA111” too. None of the users who own a vehicle of type designation “AAA111” have purchased vehicle parts compatible with a vehicle of the type designation “AAA110”. On the other hand, at least one user among the users who own a vehicle of type designation “AAA111” has purchased vehicle parts compatible with a vehicle of type designation “AAA112”.

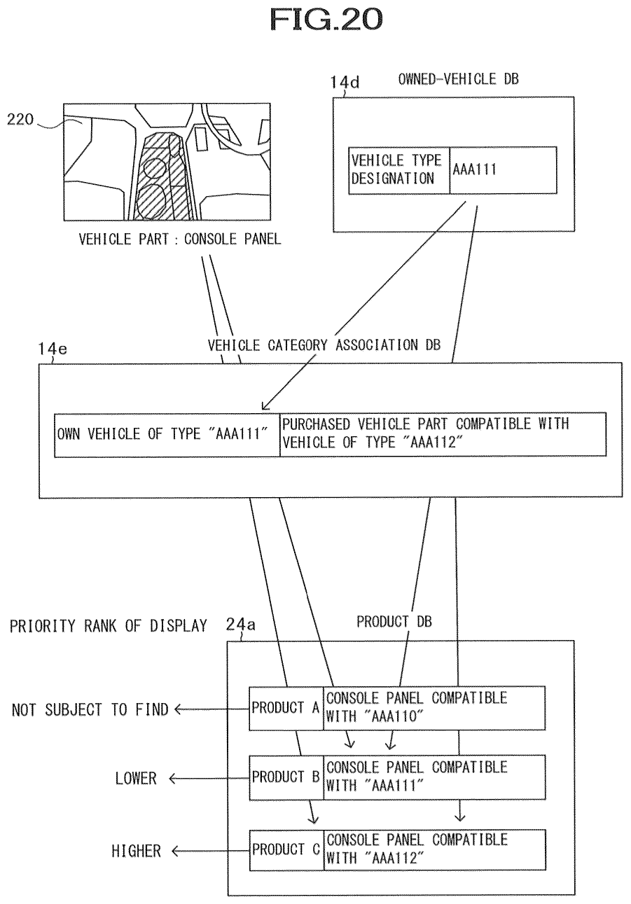

FIG. 20 is a diagram illustrating an example of a product search. For example, as illustrated in FIG. 20, the search-requesting user specified the console panel in the vehicle interior image 220 displayed on the part selection screen 100. Further, the owned-vehicle information for the search-requesting user stored in the owned-vehicle DB 14d includes the vehicle type designation “AAA111” of the vehicle owned by the search-requesting user. The first search criteria in this case includes the first vehicle category information indicating vehicle type designation “AAA111” and the specified-part information indicating “console panel”. Further, as described above, a user who owns a vehicle of vehicle type designation “AAA111” has purchased vehicle parts compatible with a vehicle of vehicle type designation “AAA112”. Therefore, the second search criteria include the second vehicle category information indicating vehicle type designation “AAA112” and the specified-part information indicating “console panel”. Assume that the product information for Products A, B, and C is stored in the product DB 24a. Product A is a console panel compatible with a vehicle of vehicle type designation “AAA110”. Product B is a console panel compatible with a vehicle of vehicle type designation “AAA111”. Product C is a console panel compatible with a vehicle of vehicle type designation “AAA112”. Vehicle type designation “AAA110” is not included in either the first search criteria or the second search criteria. Therefore, Product A is not searched for as a product satisfying the search criteria. Product B is searched for as a product satisfying the first search criteria. Product C is searched for as a product satisfying the second search criteria. Product B corresponds to the first product and Product C corresponds to the second product. Therefore, the priority rank of Product C becomes higher than the priority rank of Product B.

The search result information transmission unit 1106 may transmit, to the user terminal 3, search result information indicating the products found by the product transaction server 2 in an order corresponding to the priority ranks determined by the priority rank determination unit 1108. For example, when generating the screen information for the search result screen as an example of the search result information, the search result information transmission unit 1106 may generate the screen information such that the information on the found products is arranged on the search screen in an order corresponding to the priority ranks. For example, the product information may be arranged from top to bottom on the search result screen in descending order of priority ranks.

### 3-2-2. Product Transaction Server

Next, a functional overview of the system controller 21 in the product transaction server 2 will be described. The search criteria information reception unit 2101 may receive the first search criteria information and the second search criteria information transmitted from the automobile service server 1.

The search unit 2102 may search for the first products that satisfy the first search criteria, using the first vehicle category information and the specified-part information as the first search criteria. For example, the search unit 2102 may perform the search for the first products based on the first search criteria information received by the search criteria information reception unit 2101. Further, the search unit 2102 may search for the second products that satisfy the second search criteria, using the second vehicle category information and the specified-part information as the second search criteria. For example, the search unit 2102 may perform the search for the second products based on the second search criteria information received by the search criteria information reception unit 2101.

The search unit 2102 may search for the second products using, as the second category information, information indicating a category that is identified by the category identification unit 1107 of the automobile service server 1 as the category of a vehicle compatible with a vehicle part purchased by a user who owns a vehicle of the first category, from among the second categories. As described above, the second category information, which is transmitted by the search criteria information transmission unit 1104 of the automobile service server 1 and included in the second search criteria information received by the search criteria information reception unit 2101, indicates the category identified by the category identification unit 1107 as the category of the vehicle compatible with the vehicle part purchased by the user who owns the vehicle of the first category. Therefore, the search unit 2102 just needs to use this second category information.

The search result information transmission unit 2103 may transmit, to the automobile service server 1, the first search result information indicating the search results based on the first search criteria information by the search unit 2102. Further, the search result information transmission unit 2103 may transmit, to the automobile service server 1, the second search result information indicating the search results based on the second search criteria information by the search unit 2102. Each of the first search result information and the second search result information may include information on each found product. At this time, the search result information transmission unit 2103 does not have to determine the priority ranks for the found products.

### 3-3. Operation of Communication System

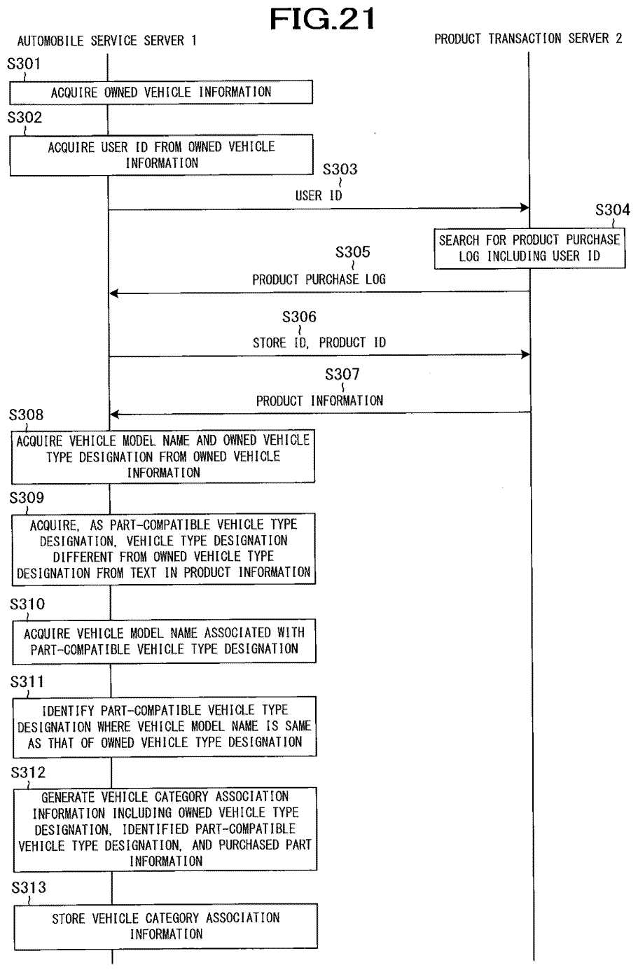

Next, the operation of the communication system S will be described with reference to FIGS. 21 to 23. FIG. 21 is a sequence diagram illustrating an example of processing by the communication system S when vehicle category association information is generated. The automobile service server 1 may execute the processing illustrated in FIG. 21 for each user whose owned-vehicle information is stored in the owned-vehicle DB 14d, for example, every time a predetermined period elapses. Examples of the predetermined period include one day, one week, one month, and the like. Note that, when vehicle purchase logs are used as described in the second embodiment, the automobile service server 1 may identify the user who purchased the vehicle based on the vehicle purchase logs. The automobile service server 1 may execute processing similar to the processing illustrated in FIG. 21 for each identified user, using the vehicle purchase logs instead of the owned-vehicle information.

As illustrated in FIG. 21, the category identification unit 1107 of the automobile service server 1 acquires targeted owned-vehicle information from the owned-vehicle DB 14d (Step S301). Next, the category identification unit 1107 acquires the user ID from the acquired owned-vehicle information (Step S302). Next, the category identification unit 1107 transmits, to the product transaction server 2, a product purchase history search request including the acquired user ID and the date and time when the processing illustrated in FIG. 21 was last performed for the user identified by this user ID (Step S303). The product transaction server 2 searches the product purchase history DB 24b for product purchase logs that include the user ID included in the product purchase history search request and include a purchase date and time on or after the date and time when the processing was last performed (Step S304). Next, the product transaction server 2 transmits each searched product purchase log to the automobile service server 1 (Step S305). The category identification unit 1107 of the automobile service server 1 acquires a combination of store ID and product ID from each product purchase log received from the product transaction server 2. The category identification unit 1107 transmits, to the product transaction server 2, a product information request including each acquired combination (Step S306). The product transaction server 2 acquires each combination of store ID and product ID from the product information request. The product transaction server 2 acquires, from the product DB 24a, the product information including each acquired combination. The product transaction server 2 transmits each acquired piece of product information to the automobile service server 1 (Step S307).

The category identification unit 1107 of the automobile service server 1, which has received the product information, acquires the vehicle model name included in the targeted owned-vehicle information as the owned vehicle model name, and acquires the vehicle type designation included in the targeted owned-vehicle information as the owned vehicle type designation (Step S308). Next, the category identification unit 1107, for each piece of received product information, extracts vehicle type designations from the text included in that product information, and identifies the extracted vehicle type designations as part-compatible vehicle type designations (Step S309). The vehicle type designations can be extracted by searching the text for each vehicle type designation stored in the vehicle DB 14a. Here, the category identification unit 1107 excludes, from the extraction targets, vehicle type designations identical to the owned vehicle type designation. Further, when the text in one piece of product information includes a plurality of mutually different vehicle type designations, the category identification unit 1107 may extract those vehicle type designations. At this time, when any one of the vehicle type designations included in the text of one piece of product information is identical to the owned vehicle type designation, the category identification unit 1107 may exclude all of those vehicle type designations from the extraction targets, or may not exclude them. Since the product information clearly states that such a vehicle part product is compatible with the vehicle of the vehicle type designation indicated by the owned vehicle type designation, even if it is compatible with vehicles of other vehicle type designation, the characteristics of that part are likely to be identical or approximately identical to the characteristics of vehicle parts that normally compatible with the vehicle of the type designation indicated by the owned vehicle type designation. Next, the category identification unit 1107 acquires, from the vehicle DB 14a, the vehicle model name associated with the vehicle type designation as each extracted part-compatible vehicle type designation, as the part-compatible vehicle model name (Step S310). Next, the category identification unit 1107 identifies, from among the extracted part-compatible vehicle type designations, the part-compatible vehicle type designations associated with the part-compatible model name matches the owned vehicle model name (Step S311). Next, the category identification unit 1107 generates, for each identified part-compatible vehicle type designation, vehicle category association information including that part-compatible vehicle type designation, the owned vehicle type designation, and the purchased part name (Step S312). For example, the category identification unit 1107 may acquire the store ID, product ID, product code, and product category information from the product information from which the identified part-compatible vehicle type designation was extracted. Further, the category identification unit 1107 may extract the product part name from the text in that product information. For example, the product part name can be extracted by searching the text for each part name stored in the parts DB 14b. When the text includes a plurality of mutually different part names, the category identification unit 1107 may extract, for example, the part name with the highest frequency of appearance in the text. The category identification unit 1107 may generate vehicle category association information including the part-compatible vehicle type designation, the owned vehicle type designation, the store ID, the product ID, the product code, the product category information, the product part name as the purchased part name, and the user ID. Next, the category identification unit 1107 stores each generated piece of vehicle category association information in the vehicle category association DB 14f (Step S313).

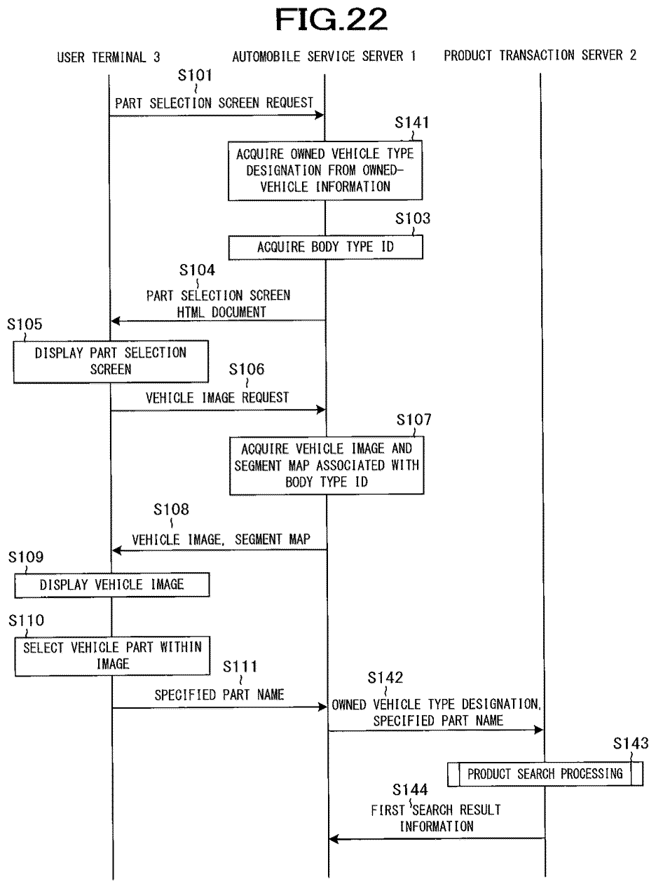

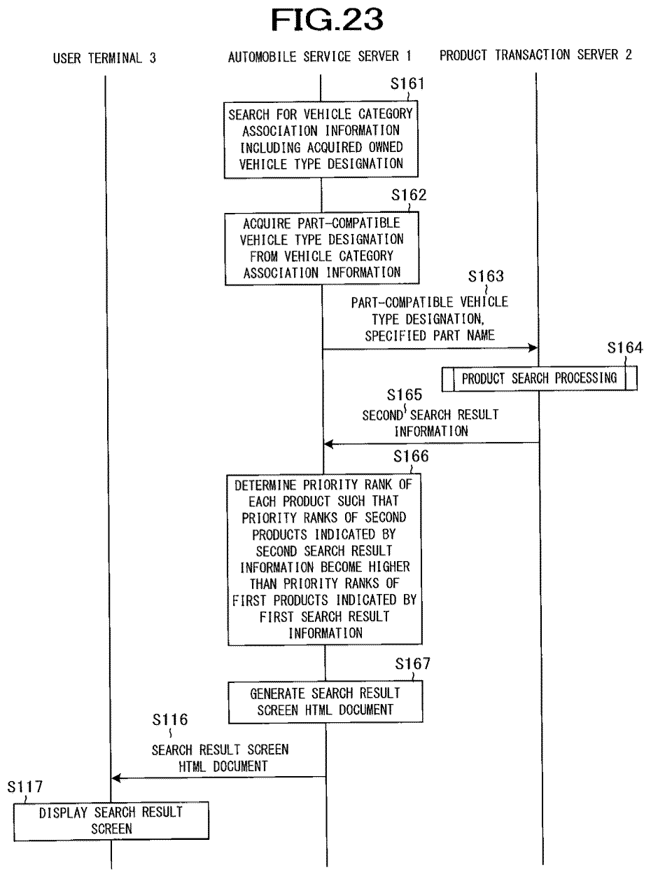

FIGS. 22 and 23 are sequence diagrams illustrating an example of processing by the communication system S when a vehicle part product search is executed. In FIGS. 22 and 23, the same processing as in FIG. 11 is denoted by the same reference numerals.

As illustrated in FIG. 22, upon receiving the part selection screen request from the user terminal 3 (Step S101), the category information acquisition unit 1101 of the automobile service server 1 acquires the vehicle type designation included in the owned-vehicle information, which is stored in the owned-vehicle DB 14d in association with the user ID included in the part selection screen request, as the owned vehicle type designation (Step S141). Next, Steps S103 to S111 are executed. After Step S111, the search criteria information transmission unit 1104 of the automobile service server 1 transmits, to the product transaction server 2, first search criteria information including the acquired owned vehicle type designation and the specified part name received from the user terminal 3 (Step S142). The search unit 2102 of the product transaction server 2, which has received the first search criteria information, executes product search processing using, as search criteria, the owned vehicle type designation and the specified part name included in the first search criteria information (Step S143). Next, the search result information transmission unit 2103 of the product transaction server 2 transmits the search result information generated in the product search processing to the automobile service server 1 as first search result information (Step S144).

The search criteria information transmission unit 1104 of the automobile service server 1, which has received the first search result information, searches the vehicle category association DB 14f for vehicle category association information including an owned vehicle type designation that matches the acquired owned vehicle type designation (Step S161). Next, the search criteria information transmission unit 1104 acquires the part-compatible vehicle type designation from each piece of found vehicle category association information (Step S162). At this time, the part-compatible vehicle type designation may be acquired only from the vehicle category association information that includes a purchased part name matching the specified part name, among the searched vehicle category association information. Next, the search criteria information transmission unit 1104 transmits, to the product transaction server 2, second search criteria information including the acquired part-compatible vehicle type designation and the specified part name (Step S163). When multiple relevant pieces of vehicle category association information are found, the second search criteria information may include multiple part-compatible vehicle type designations. The search criteria information transmission unit 1104 may generate the second search criteria information such that the second search criteria information includes mutually different multiple part-compatible vehicle type designations. The search unit 2102 of the product transaction server 2, which has received the second search criteria information, executes the product search processing using, as search criteria, the part-compatible vehicle type designation and the specified part name included in the second search criteria information (Step S164). When the second search criteria information includes multiple part-compatible vehicle type designations, the search unit 2102 searches for products whose product information text includes at least one of those multiple part-compatible vehicle type designations and also includes the specified part name. Next, the search result information transmission unit 2103 of the product transaction server 2 transmits the search result information generated in the product search processing to the automobile service server 1 as second search result information (Step S165).

The priority rank determination unit 1108 of the automobile service server 1, which has received the second search result information, determines the priority ranks for first products and second products such that the priority ranks of the second products, indicated by the combinations of store ID and product ID included in the second search result information as products satisfying the second search criteria, becomes higher than the priority ranks of the first products, indicated by the combinations of store ID and product ID included in the first search result information as products satisfying the first search criteria (Step S166). For example, the priority rank determination unit 1108 may assign the priority ranks to the second products starting from the first rank. Further, the priority rank determination unit 1108 may assign the priority ranks to the first products starting from the rank corresponding to the number calculated by adding 1 to the number of found second products. Next, the search result information transmission unit 1106 generates the HTML document for the search result screen (Step S167). For example, the search result information transmission unit 1106 may generate information for displaying the product name, product image, price, and the like, for each product. The search result information transmission unit 1106 may add the generated information for each product to the HTML document for the search result screen such that the information for each product is arranged from top to bottom in accordance with the priority ranks. Next, the search result information transmission unit 1106 transmits the generated HTML document to the user terminal 3 (Step S116). The user terminal 3 displays the search result screen based on this HTML document (Step S117).

As explained above, according to the present embodiment, first products of the vehicle part located at the position specified by the user, which are compatible with the vehicle owned by the user, are searched for. Further, second products of the vehicle part located at the position specified by the user, which are compatible with a vehicle of the second vehicle category different from the first vehicle category of the vehicle owned by the user, are searched for. Then, the second products are presented to the user with higher priority than the first products. Each of the first vehicle category and the second vehicle category is included in the mutually same category. Therefore, even if the product information does not indicate that it is compatible with the vehicle of the first vehicle category, the vehicle part compatible with the vehicle of the second vehicle category potentially is compatible also with the vehicle of the first vehicle category. On the other hand, the characteristics of the vehicle part indicated by the product information as compatible with the vehicle of the second vehicle category may be different from the characteristics of the vehicle part indicated by the product information as compatible with the vehicle of the first vehicle category. Therefore, it is possible to present to the user, with higher priority than the vehicle parts that are normally compatible with the vehicle owned by the user, the vehicle part products that are potentially compatible with the vehicle owned by the user and may have characteristics different from the vehicle parts that are normally compatible with the vehicle owned by the user.

Here, the automobile service server 1 may identify, based on owned vehicle category information indicating the categories of vehicles owned respectively by a plurality of users, product purchase history information, and product information, the category of the vehicle owned by a respective user and the category of the vehicle compatible with the vehicle part purchased by that user, Further, the product transaction server 2 may use, for the product search, information indicating a category that is identified as the category of a vehicle compatible with a vehicle part purchased by a user who owns a vehicle of the first vehicle category from among the second vehicle categories, and used information is regard as the second vehicle category information. In this case, it is possible to identify the category of the vehicle compatible with a vehicle part purchased by a user who owns a vehicle of the same category as the category of the vehicle owned by the user to whom the search results are provided. Then, vehicle part products compatible with a vehicle of the same category as the category of the vehicle compatible with the purchased vehicle part among the second vehicle categories different from the first vehicle category of the vehicle owned by the user, are searched for as the second products. The vehicle part purchased by the user who owns a vehicle of the same category as the category of the vehicle owned by the user to whom the search results are provided potentially is compatible with the vehicle owned by the user to whom the search results are provided. Therefore, it is possible that the same vehicle part can be used between the vehicle owned by the user to whom the search results are provided and the vehicle of the category compatible with the purchased vehicle part. Thus, it is possible to search for vehicle part products that may have characteristics different from the vehicle parts that normally compatible with the vehicle owned by the user, and are highly probable to compatible with the vehicle owned by the user.

### 4. Fourth Embodiment

Next, a fourth embodiment will be described. Except for the points described below, the present embodiment may be the same as at least one of the embodiments described so far. In the embodiments described so far, the automobile service server 1 transmitted the vehicle image to the user terminal 3. However, the user terminal 3 may acquire the vehicle image from an acquisition source different from the automobile service server 1. For example, the user may photograph the vehicle using the user terminal 3 or another device. The user terminal 3 may acquire the image of the photographed vehicle. Further, for example, the user may download a vehicle image from some website to the user terminal 3. The user terminal 3 may display the vehicle image acquired in this way. Further, the user terminal 3 may transmit this vehicle image to the automobile service server 1. The automobile service server 1 may execute processing to associate each coordinate (or each pixel) within the vehicle image acquired from the user terminal 3 with a vehicle part, using, for example, image recognition technology. For example, as described above, the automobile service server 1 may generate a segment map indicating the association between each coordinate within the vehicle image and a vehicle part, using segmentation. The user terminal 3 or the automobile service server 1 may identify the vehicle part located at the position specified by the user operation within the vehicle image and acquire the specified-part information, based on this segment map. Further, the automobile service server 1 may acquire the owned vehicle category information based on the vehicle image acquired from the user terminal 3. For example, assume that the user is instructed to upload an image of a photograph of the vehicle owned by the user to the automobile service on the website of the automobile service. In this case, the vehicle image acquired from the user terminal 3 can be regarded as an image of the vehicle owned by the user. The automobile service server 1 may identify the category of the vehicle depicted in this vehicle image by image recognition. The automobile service server 1 may acquire owned vehicle category information indicating the identified category. Further, regardless of whether the user terminal 3 acquires the vehicle image from the automobile service server 1 or acquires it from another acquisition source, the automobile service server 1 may be configured such that the category of the vehicle owned by the user can be designated by the search-requesting user at the time of searching for part products. The automobile service server 1 may acquire information indicating the designated category from the user terminal 3 as the owned vehicle category information.

(1) A product search system comprising: at least one memory configured to store computer program code; and at least one processor configured to access the memory and operate as instructed by the computer program code, the computer program code comprising: category information acquisition code configured to cause at least one of the at least one processor to acquire category information indicating a category of a vehicle owned by a user; part information acquisition code configured to cause at least one of the at least one processor to acquire part information for identifying a vehicle part located at a position specified by a user operation within an image of a vehicle displayed on a terminal device of the user; search code configured to cause at least one of the at least one processor to search for products by accessing a storage storing thereon product information on vehicle part products and by using the acquired category information and the acquired part information as search criteria; and search result transmission code configured to cause at least one of the at least one processor to transmit search result information indicating results of the search to the terminal device.

(2) The product search system according to (1), wherein the category information acquisition code is configured to cause at least one of the at least one processor to acquire the category information based on registered-vehicle information indicating the vehicle owned by the user, the registered-vehicle information being preregistered by the user.

(3) The product search system according to (1) or (2), wherein the category information acquisition code is configured to cause at least one of the at least one processor to acquire the category information based on purchased-vehicle history information indicating a purchase history of vehicles by the user.

(4) The product search system according to any one of (1) to (3), wherein the computer program code further comprises image transmission code configured to cause at least one of the at least one processor to transmit, to the terminal device, an image of a vehicle corresponding to the acquired category information as the image to be displayed on the terminal device.

(5) The product search system according to any one of (1) to (4), wherein the category indicated by the category information is a first category among two or more categories included in a same category, the search code is configured to cause at least one of the at least one processor to: use the category information and the part information as first search criteria and search for first products meeting the first search criteria, and use second category information indicating at least one second category among the two or more categories and the part information as second search criteria and search for second products meeting the second search criteria, the at least one second category is different from the first category, the computer program code further comprises priority rank determination code configured to cause at least one of the at least one processor to determine priority ranks of the first products and the second products found by the search, determining the priority ranks includes giving higher priority ranks to the second products than the priority ranks of the first products, and the search result information transmission code is configured to cause at least one of the at least one processor to transmit the search result information indicating the first products and the second products arranged in an order corresponding to the determined priority ranks.

(6) The product search system according to (5), wherein at least one piece of the product information on at least one of the vehicle part products includes information indicating a category of a vehicle that is compatible with the at least one of the vehicle part products, the computer program code further comprises category identification code configured to cause at least one of the at least one processor to identify at least one category of at least one vehicle owned by at least one user among two on more users and at least one category of at least one vehicle that is compatible with at least one vehicle part purchased by the at least one user, based on owned-vehicle category information indicating categories of two or more vehicles owned by the two or more users, product purchase history information indicating a purchase history of vehicle part products, and the product information, the product purchase history information indicates purchased vehicle part products and users who purchased the vehicle part products, and the search code is configured to cause at least one of the at least one processor to use, as the second category information, information indicating a category that is included in the at least one second category and is identified as a category of a vehicle that is compatible with a vehicle part purchased by a user who owns a vehicle of the first category.

(7) The product search system according to (5) or (6), wherein the same category is a group of vehicles of a same model, and each of the first category and the second category is a group of vehicles of a same type designation.

(8) A product search method performed by at least one computer, the method comprising: acquiring category information indicating a category of a vehicle owned by a user; acquiring part information for identifying a vehicle part located at a position specified by a user operation within an image of a vehicle displayed on a terminal device of the user; searching for products by accessing a storage storing thereon product information on vehicle part products and by using the acquired category information and the acquired part information as search criteria; and transmitting search result information indicating results of the search to the terminal device.

(9) A non-transitory computer readable medium having stored thereon a product search program which, when executed by at least one processor, causes a computer to: acquire category information indicating a category of a vehicle owned by a user; acquire part information for identifying a vehicle part located at a position specified by a user operation within an image of a vehicle displayed on a terminal device of the user; search for products by accessing a storage storing thereon product information on vehicle part products and by using the acquired category information and the acquired part information as search criteria; and transmit search result information indicating results of the search to the terminal device.

### REFERENCE SIGNS LIST

1 Automobile Service Server
2 Product Transaction Server
3 User Terminal
11, 21 System controller
12, 22 System Bus
13, 23 Input/Output Interface
14, 24 Storage Unit
15, 25 Communication Unit
14a Vehicle Database (DB)
14b Parts Database (DB)
14c Vehicle Image Database (DB)
14d Owned Vehicle Database (DB)
14e Vehicle Purchase History Database (DB)
14f Vehicle Category Association Database (DB)
24a Product Database (DB)
24b Product Purchase History Database (DB)
1101 Category Information Acquisition Unit
1102 Image Transmission Unit
1103 Part information acquisition unit
1104 Search criteria Information Transmission Unit
1105 Search Result Information Reception Unit
1106 Search Result Information Transmission Unit
1107 Category Specification Unit
1108 Priority Determination Unit
2101 Search criteria Information Reception Unit
2102 Search Unit
2103 Search Result Information Transmission Unit
NW Network

What is claimed is:

1. A computer architecture for interactive image based database searching that improves search accuracy and reduces computational overhead by correlating user-specified image positions with vehicle part compatibility data, the system comprising:
at least one memory configured to store computer program code and a segment map associating pixel coordinates of a vehicle image with vehicle part identifiers; and
at least one processor configured to access the memory and operate as instructed by the computer program code, the computer program code comprising:
category information acquisition code configured to cause at least one of the at least one processor to acquire category information indicating a category of a vehicle owned by a user;
image processing code configured to cause at least one of the at least one processor to:
receive coordinate data corresponding to a position specified by a user operation within an image of a vehicle displayed on a terminal device of the user, and
access the segment map to identify a vehicle part identifier corresponding to the coordinate data;
part information acquisition code configured to cause at least one of the at least one processor to acquire part information for identifying the vehicle part based on the vehicle part identifier obtained from the segment map;
search code configured to cause at least one of the at least one processor to search for products by:
accessing a storage storing thereon product information on vehicle part products,
filtering the product information using the acquired category information to identify products compatible with the vehicle owned by the user,
further filtering using the acquired part information to identify products corresponding to the identified vehicle part, and
generating a filtered product set based on both the category information and the part information;
and
search result transmission code configured to cause at least one of the at least one processor to transmit search result information indicating the filtered product set to the terminal device.

2. The computer architecture according to claim 1, wherein the category information acquisition code is configured to cause at least one of the at least one processor to acquire the category information based on registered-vehicle information indicating the vehicle owned by the user, the registered-vehicle information being preregistered by the user.

3. The computer architecture according to claim 1, wherein the category information acquisition code is configured to cause at least one of the at least one processor to acquire the category information based on purchased-vehicle history information indicating a purchase history of vehicles by the user.

4. The computer architecture according to claim 1, wherein the computer program code further comprises image transmission code configured to cause at least one of the at least one processor to transmit, to the terminal device, an image of a vehicle corresponding to the acquired category information as the image to be displayed on the terminal device.

5. The computer architecture according to claim 1, wherein
the category indicated by the category information is a first category among two or more categories included in a same category,
the search code is configured to cause at least one of the at least one processor to:
use the category information and the part information as first search criteria and search for first products meeting the first search criteria, and
use second category information indicating at least one second category among the two or more categories and the part information as second search criteria and search for second products meeting the second search criteria,
the at least one second category is different from the first category,
the computer program code further comprises priority rank determination code configured to cause at least one of the at least one processor to determine priority ranks of the first products and the second products found by the search,
determining the priority ranks includes giving higher priority ranks to the second products than the priority ranks of the first products, and
the search result information transmission code is configured to cause at least one of the at least one processor to transmit the search result information indicating the first products and the second products arranged in an order corresponding to the determined priority ranks.

6. The computer architecture according to claim 5, wherein
at least one piece of the product information on at least one of the vehicle part products includes information indicating a category of a vehicle that is compatible with the at least one of the vehicle part products,
the computer program code further comprises category identification code configured to cause at least one of the at least one processor to identify at least one category of at least one vehicle owned by at least one user among two on more users and at least one category of at least one vehicle that is compatible with at least one vehicle part purchased by the at least one user, based on owned-vehicle category information indicating categories of two or more vehicles owned by the two or more users, product purchase history information indicating a purchase history of vehicle part products, and the product information,
the product purchase history information indicates purchased vehicle part products and users who purchased the vehicle part products, and
the search code is configured to cause at least one of the at least one processor to use, as the second category information, information indicating a category that is included in the at least one second category and is identified as a category of a vehicle that is compatible with a vehicle part purchased by a user who owns a vehicle of the first category.

7. The computer architecture according to claim 5, wherein
the same category is a group of vehicles of a same model, and
each of the first category and the second category is a group of vehicles of a same type designation.

8. A product search method performed by at least one computer, the method comprising:
storing, in memory, a segment map associating pixel coordinates of a vehicle image with vehicle part identifiers;
acquiring category information indicating a category of a vehicle owned by a user;
acquiring category information indicating a category of a vehicle owned by a user;
receiving coordinate data corresponding to a position specified by a user operation within an image of a vehicle displayed on a terminal device of the user;
accessing the segment map to identify a vehicle part identifier corresponding to the coordinate data;
acquiring part information for identifying a vehicle part based on the vehicle part identifier obtained from the segment map;
searching for products by:
accessing a storage storing thereon product information on vehicle part products,
filtering the product information using the acquired category information to identify products compatible with the vehicle owned by the user, and
further filtering using the acquired part information to identify products corresponding to the identified vehicle part; and
transmitting search result information indicating results of the search to the terminal device.

9. A non-transitory computer readable medium having stored thereon a product search program which, when executed by at least one processor, causes a computer to:
acquire category information indicating a category of a vehicle owned by a user;
acquire part information for identifying a vehicle part located at a position specified by a user operation within an image of a vehicle displayed on a terminal device of the user;
search for products by accessing a storage storing thereon product information on vehicle part products and by using the acquired category information and the acquired part information as search criteria; and
transmit search result information indicating results of the search to the terminal device.

10. The computer architecture according to claim 1, wherein the segment map is generated by:
performing image segmentation on the vehicle image using a trained machine learning model to identify regions corresponding to respective vehicle parts;
assigning vehicle part identifiers to pixel coordinates within each identified region; and
storing the segment map in the memory in association with the vehicle image, wherein subsequent user operations on the same vehicle image have reduced processing times than prior user operations.

11. The computer architecture according to claim 1, further comprising:
a first server configured to execute the category information acquisition code and the part information acquisition code; and
a second server configured to execute the search code,
wherein the first server is configured to transmit search criteria information including the category information and the part information to the second server, and the second server is configured to transmit the search result information to the first server for transmission to the terminal device.

12. The computer architecture according to claim 11, wherein the first server is further configured to:
store owned-vehicle information indicating vehicles owned by a plurality of users;
receive a request from the terminal device including a user identifier; and
acquire the category information from the owned-vehicle information associated with the user identifier.

13. The computer architecture according to claim 11, wherein the first server is further configured to:
store vehicle image data and segment map data for a plurality of vehicle categories;
identify a vehicle category corresponding to the category information; and
transmit, to the terminal device, vehicle image data and segment map data corresponding to the identified vehicle category.

14. The computer architecture according to claim 11, wherein the second server is further configured to:
store the product information including, for each vehicle part product, at least one of a product name, a catchphrase, and a product description; and
search for products by identifying product information that includes text matching the category information and text matching the part information.

15. The computer architecture according to claim 11, wherein the second server is further configured to:
determine a priority rank for each product in the filtered product set based on a popularity level of the product; and
include the priority rank for each product in the search result information transmitted to the first server.

16. The computer architecture according to claim 11, wherein the first server is further configured to:
receive the search result information from the second server; generate screen information for a search result screen based on the search result information; and
transmit the screen information to the terminal device.

17. The computer architecture according to claim 11, wherein:
the first server is configured to provide an automobile service including at least one of vehicle sales, vehicle trade-in, and reservation brokerage for vehicle inspection or repair; and
the second server is configured to provide a product transaction service enabling purchase of vehicle part products via electronic commerce.

18. The computer architecture according to claim 13, wherein the first server is further configured to:
receive, from the terminal device, coordinate data indicating a position specified by the user operation within the vehicle image displayed on the terminal device; and
acquire the part information by accessing the segment map data to identify a vehicle part identifier corresponding to the coordinate data.

19. The computer architecture according to claim 13, wherein the terminal device is configured to:
receive the vehicle image data and the segment map data from the first server;
identify, based on the segment map data, a vehicle part identifier corresponding to a position specified by the user operation; and
transmit the vehicle part identifier to the first server as the part information.

20. The computer architecture of claim 11, wherein the first server is configured to search a vehicle database, a parts database, a vehicle image database, and an owned vehicle database and the second server is configured to search a product database and a product purchase history database.
